(19) United States
(12) Patent Application Publication
(10) Pub. No.: US 2026/0147512 A1
(43) Pub. Date: May 28, 2026

(54) STORAGE MEDIUM, SUPPORT METHOD, AND INFORMATION PROCESSING APPARATUS FOR ENABLING GRAYSCALE CONVERSION INSTRUCTIONS

(71) Applicant: CANON KABUSHIKI KAISHA, Tokyo (JP)

(72) Inventor: KIMIMORI EGUCHI, Chiba (JP)

(21) Appl. No.: 19/342,864

(22) Filed: Sep. 29, 2025

(30) Foreign Application Priority Data
Nov. 25, 2024 (JP) 2024-204616

(51) Int. Cl. G06F 3/12

(52) U.S. Cl. CPC G06F 3/1255; G06F 3/1208; G06F 3/1228

(57) ABSTRACT

A non-transitory computer readable storage medium stores a computer program configured to support a standard driver that causes an information processing apparatus to obtain capability information of an image processing apparatus according to Internet Printing Protocol. The computer program causes the information processing apparatus to display a setting reception screen to receive a setting for grayscale conversion to convert a color image to a grayscale image and instruct the image processing apparatus to perform the grayscale conversion based on the setting received through the setting reception screen. The setting reception screen includes a method selection section configured to allow selection of a method for the grayscale conversion as the setting.

### BACKGROUND

### Field of the Technology

The present disclosure relates to a storage medium, a support method, and an information processing apparatus.

### Description of the Related Art

A printer that performs printing is communicatively connected to a host computer (information processing apparatus) capable of processing information with the printer. For example, a printer driver is installed from the printer to the host computer and used as software for controlling the printer. The printer driver allows the host computer to issue print instructions to the printer. The host computer is pre-installed with an operating system (OS), which is basic software. The printer driver is configured in accordance with specifications defined by the OS and can operate when invoked by the OS. Such a printer driver varies depending on the vendor that supplies the printer, i.e., it is a model-specific driver tailored to each printer.

In recent years, in Windows® systems, a standard class driver (hereinafter sometimes referred to as a “standard driver”) has been provided that can be commonly used with printers supplied by different vendors. Such a standard driver is pre-installed in the OS. Accordingly, the standard driver can be used by connecting any printer to a host computer having an OS with the standard driver incorporated. This eliminates the need to install the aforementioned model-specific printer driver. Additionally, the standard driver can be used to specify print functions of the printer according to Print Device Capabilities (PDC) generated based on information acquired from the printer. This allows a single standard driver to specify print functions for each printer. The standard driver can be associated with a function extension application (hereinafter sometimes referred to as an “extension application”) that extends functions. The extension application is provided by each vendor. Therefore, it is difficult to implement the functions of the extension application with the standard driver alone.

Japanese Patent Application Laid-Open No. 2021-033526 discloses an extension application that extends functions to enable vendor-specific printing such as color printing, poster printing, and booklet printing.

As described above, the printer driver varies depending on the vendor that supplies the printer, i.e., it is a model-specific driver tailored to each printer. This printer driver can cause the printer to perform vendor-specific color printing. By contrast, the standard driver can cause the printer to perform general (standard) color printing that is not vendor-specific. However, the standard driver cannot cause the printer to perform printing in which a color image is converted to a grayscale image and the tone of the grayscale image is adjusted.

### SUMMARY

Embodiments described herein are directed to technology for instructing an image processing apparatus to perform grayscale conversion, which converts a color image to a grayscale image.

In one embodiment, a non-transitory computer readable storage medium stores a computer program configured to support a standard driver that causes an information processing apparatus to obtain capability information of an image processing apparatus according to Internet Printing Protocol. The computer program causes the information processing apparatus to display a setting reception screen configured to receive a setting for grayscale conversion to convert a color image to a grayscale image and instruct the image processing apparatus to perform the grayscale conversion based on the setting received through the setting reception screen. The setting reception screen includes a method selection section configured to allow a selection of a method for the grayscale conversion as the setting.

In another embodiment, the computer program may cause the information processing apparatus to generate image data with the grayscale conversion already applied based on the setting received through the setting reception screen and transmit the generated image data to the image processing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of the hardware configuration of a printing system according to a first embodiment.

FIGS. 2A and 2B are block diagrams each illustrating an example of the software configuration of the printing system.

FIGS. 3A to 3D are diagrams each illustrating an example of a screen displayed on a display of the printing system.

FIG. 4 is a diagram illustrating an example of a table for explaining the effects of grayscale conversion methods.

FIGS. 5A to 5C are conceptual diagrams illustrating the effects of the grayscale conversion methods.

FIG. 6 is a flowchart illustrating a process in which a print function extension unit edits print function information.

FIG. 7 is a diagram illustrating an example of a list of capability information of a printer.

FIG. 8 is a diagram illustrating an example of a list of print functions supported by an extension application.

FIG. 9 is a diagram illustrating an example of a list of capability information of general-purpose printing software.

FIG. 10 is a sequence diagram illustrating processes performed among a rendering application, general-purpose printing software, an extension application, and a printer after the rendering application receives print settings.

FIG. 11 is a block diagram illustrating an example of the software configuration of a printing system according to a second embodiment.

FIG. 12 is a flowchart illustrating a process in which a print function extension unit edits print function information.

FIG. 13 is a sequence diagram illustrating processes performed among a rendering application, general-purpose printing software, an extension application, and a printer after the rendering application receives print settings.

FIG. 14 is a block diagram illustrating an example of the software configuration of a printing system according to a third embodiment.

FIG. 15 is a flowchart illustrating a process in which a print function extension unit edits print function information.

FIG. 16 is a diagram illustrating an example of a list of capability information.

FIG. 17 is a diagram illustrating an example of a screen displayed on a display of the printing system.

FIG. 18 is a graph illustrating an example of a lookup table (LUT) used in a “darken” process.

FIGS. 19A and 19B are conceptual diagrams illustrating the effects of gray conversion processes other than the grayscale conversion methods.

FIGS. 20A to 20C are conceptual diagrams illustrating the effects of “distinguishing” processes.

FIG. 21 is a sequence diagram illustrating processes performed among a rendering application, general-purpose printing software, an extension application, and a printer after the rendering application receives print settings.

### DESCRIPTION OF THE EMBODIMENTS

Example embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding parts, and duplicative descriptions thereof are omitted to avoid redundancy.

### First Embodiment

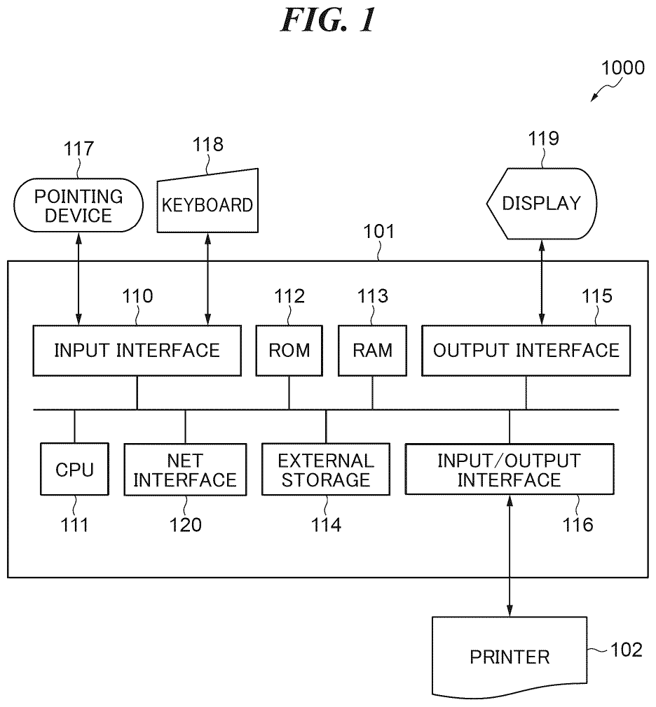

A first embodiment will be described below with reference to FIGS. 1 to 10.

### Hardware Configuration of the Printing System

FIG. 1 is a block diagram illustrating an example of the hardware configuration of a printing system according to the first embodiment. As illustrated in FIG. 1, a printing system 1000 includes a host computer 101, a printer 102, a pointing device 117, a keyboard 118, and a display 119, which are communicatively connected to one another. The host computer 101 is an information processing apparatus and includes an input interface 110, a CPU 111, a ROM 112, a RAM 113, an external storage (storage medium) 114, an output interface 115, an input/output interface 116, and a network (NET) interface 120. The host computer 101 may be, for example, a desktop personal computer; however, it is not limited thereto and may alternatively be a notebook personal computer, a tablet device, a smartphone, or the like.

The CPU 111 is a processor that executes computer programs stored in the ROM 112 or the external storage 114. Accordingly, the CPU 111 is capable of performing each process (control method) described below. The ROM 112 stores an initialization program. The external storage 114 stores application programs, an operating system (OS), print data generation software, and various other data. In this embodiment, the host computer 101 is equipped with Microsoft® Windows® 11 as its operating system. The RAM 113 is used, for example, as a work memory during execution of the various programs stored in the external storage 114, whereby these programs can run on the host computer 101. Input devices such as the pointing device 117 and the keyboard 118 are connected to the input interface 110. A display device such as the display 119 is connected to the output interface 115. The display 119 displays a print settings screen (300A) and an advanced settings screen (300C) described below. The network interface 120 is configured to control data transfer with external devices via a network. The printer 102 is connected to the input/output interface 116. This allows the host computer 101 to communicate with a plurality of printers (102) regardless of manufacturer, that is, to process information with a plurality of printers (102) from different manufacturers.

The printer 102 may be, for example, an image forming apparatus such as a multifunction peripheral (MFP) having a plurality of functions including copying, printing, and faxing; however, it is not limited thereto. In this embodiment, printing performed by the printer 102 is assumed to be electrophotographic printing; however, it is not limited thereto and may be, for example, inkjet printing or the like. In this embodiment, the host computer 101 and the printer 102 are configured as separate devices; however, they are not limited to this configuration. For example, the host computer 101 and the printer 102 may be integrated as a single device.

### Software-Centric Configuration of the Printing System

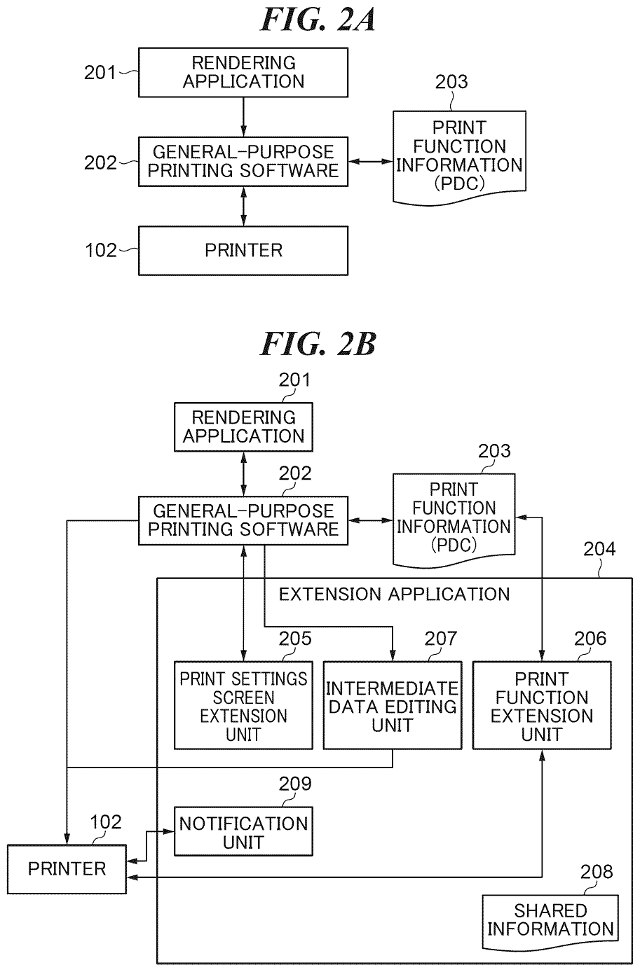

FIGS. 2A and 2B are block diagrams each illustrating an example of the software configuration of the printing system. FIG. 2A illustrates a general configuration in which an extension application (application program) 204 is not associated with general-purpose printing software (standard driver) 202 and the printer 102. FIG. 2B illustrates a configuration in which the extension application 204 is associated with the general-purpose printing software 202 and the printer 102. The general-purpose printing software 202 is a standard driver provided by the provider of the OS. The standard driver is a class driver (general-purpose program) that can be commonly used, for example, during printing, with printers (102) from a plurality of manufacturers. The standard driver is pre-installed (incorporated) in the OS, that is, it is provided as one of the functions in the OS package. The standard driver can perform processing for various printers by utilizing a standardized printing method. Accordingly, the standard driver can generate and output instructions interpretable by printers from a plurality of manufacturers. The general-purpose printing software 202 may be a program operating based on the Internet Printing Protocol (IPP). The extension application 204 is a program that supports, i.e., assists, the general-purpose printing software 202. In this embodiment, the extension application 204 is an extensible program (a program that implements a control method) capable of providing functions that cannot be performed on the printer 102 by the general-purpose printing software 202; however, it is not limited thereto. For example, the extension application 204 may be a program that improves the convenience of functions that can be performed on the printer 102 by the general-purpose printing software 202. The extension application 204 is stored, for example, in the external storage 114 along with the OS (general-purpose printing software 202). Accordingly, the host computer 101 has the general-purpose printing software 202 and the extension application 204.

### Case Where the Extension Application is Not Associated

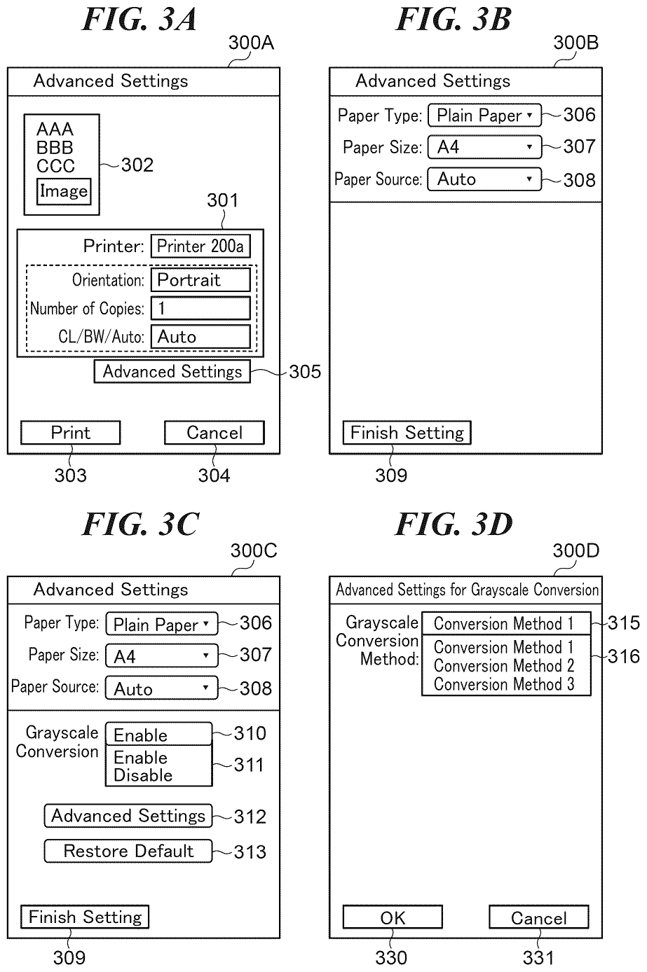

First, with reference to FIG. 2A, a configuration will be described in which the extension application 204 is not associated with the general-purpose printing software 202 and the printer 102. A rendering application 201 is software used to create content (print data) to be printed by the printer 102. The rendering application 201 is not particularly limited and may be, for example, a word processing application or a spreadsheet application. The rendering application 201 issues a print instruction to the OS, for example, in response to a print request from a user through the keyboard 118. The print instruction includes print settings information for instructing the operation of the general-purpose printing software 202 and the printer 102. The print settings information is also referred to as a “Print Ticket (PT).” In addition, to output the print settings information, the rendering application 201 can cause the display 119 to display a print settings screen 300A (see FIG. 3A), which may be provided by any of the general-purpose printing software 202, the OS, or the rendering application 201. By operating (pressing) a control 305 on the print settings screen 300A, an advanced settings screen 300B (see FIG. 3B) or an advanced settings screen 300C (see FIG. 3C) can be displayed on the display 119. The print settings screen 300A through the advanced settings screen 300C will be described below. The print settings screen 300A includes setting items indicating configurable print functions and control items indicating their setting values, according to capability information obtained from the general-purpose printing software 202, i.e., information that can be set as print settings. The capability information relates to the printing capabilities of the printer 102 and is also referred to as “Print Capabilities (PC).” It can also be determined whether the capability information includes information that enables the display of the advanced settings screen 300C. If it is determined, as a result of this determination, that the capability information includes information enabling the display of the advanced settings screen 300C, the advanced settings screen 300C can be displayed. Conversely, if it is determined that the capability information does not include information enabling the display of the advanced settings screen 300C, the advanced settings screen 300C is not displayed. In this manner, the extension application 204 can switch whether or not to display the advanced settings screen 300C based on the capability information of the printer 102.

The general-purpose printing software 202 determines the capability information (PC) based on print function information 203. The print function information 203 is data indicating print functions, which describes all configurable print functions and their setting values, as well as any mutually exclusive relationships among the setting values. The print function information 203 is also referred to as “Print Device Capabilities (PDC).” The print function information 203 is included in a configuration file of the general-purpose printing software 202 and is stored in the external storage 114 as a non-editable file. Alternatively, the print function information 203 may be dynamically generated by the general-purpose printing software 202. Specifically, the general-purpose printing software 202 acquires attribute data of the printer 102 from the printer 102. The general-purpose printing software 202 generates the print function information 203 according to the attribute information contained in the attribute data. In cases where the print function information 203 is dynamically generated in this manner, the print function information 203 can be edited. The attribute data of the printer 102 is obtained as a response by issuing a “Get-Printer-Attributes” operation, defined in the IPP, to the printer 102. This response includes attribute information indicating functions that can be specified on the printer 102, i.e., attribute information indicating the capabilities of the printer 102, and setting values related to that attribute information. The response is stored in the RAM 113.

With this configuration, the general-purpose printing software 202 allows the user to specify print functions available on the printer 102 according to the printer 102 connected to the general-purpose printing software 202. Accordingly, it is possible to specify print functions available on the connected printer 102 regardless of the type of printer connected to the general-purpose printing software 202, that is, even when a printer having different functions or a printer developed by a different printer manufacturer is connected. In this embodiment, the general-purpose printing software 202 is assumed to use the IPP Class Driver included in Windows® 11. The IPP Class Driver is a printer driver that performs printing in accordance with the specification of a standard printing protocol called IPP and is included in the OS package. The IPP Class Driver is not a proprietary printer driver specific to the model of the printer 102 but a standard class driver that can be commonly used with printers (102) from different printer manufacturers. The IPP Class Driver acquires capability information of the printer 102 and generates the print function information 203 based on the information.

The general-purpose printing software 202 can also be associated with the extension application 204. This allows the general-purpose printing software 202 to perform functions that are not inherently available in the general-purpose printing software 202. For example, the IPP Class Driver (general-purpose printing software 202) cannot perform a function to receive a setting for converting a color image to a grayscale image (hereinafter referred to as “grayscale conversion setting”). This is because the grayscale conversion setting function is a function performed exclusively by a printer manufactured by a specific printer manufacturer. The extension application 204 can extend the functionality to enable execution of the grayscale conversion setting function that the IPP Class Driver cannot perform. In this embodiment, the IPP Class Driver cannot perform the grayscale conversion setting function, and the extension application 204 can extend the functionality to enable execution of the grayscale conversion setting function; however, the embodiment is not limited thereto. For example, the IPP Class Driver may be able to perform part of the grayscale conversion setting function, and the extension application 204 may supplement the rest, thereby further extending the execution range.

The OS generates intermediate data (also referred to as “input data”) based on a print instruction output from the rendering application 201 and transmits the intermediate data to the general-purpose printing software 202. The data output from the rendering application 201 for printing is not particularly limited and may be, for example, data in the XML Paper Specification (XPS) format. The data output from the rendering application 201 for printing may alternatively be data in the Graphic Device Interface (GDI) format. When the IPP Class Driver is used as the general-purpose printing software 202, if the data output from the rendering application 201 is in the GDI format, the OS converts the GDI format data into XPS format data. The OS then transmits the converted XPS format data to the general-purpose printing software 202 as the intermediate data. If the data output from the rendering application 201 is in the XPS format, the OS transmits the XPS format data as the intermediate data to the general-purpose printing software 202 without conversion. The intermediate data includes rendering data, which is information such as text or graphics to be formed on a print medium, and print settings information set by the user.

The general-purpose printing software 202 converts the intermediate data into print data (image data) that can be processed by the printer 102, i.e., printable by the printer 102, and transmits the print data to the printer 102. In this embodiment, the term “print data” refers to Page Description Language (PDL) data in compliance with IPP. Examples of the PDL data include data in Portable Document Format (PDF) or PWG Raster format. The print data includes rendering data, which is information such as text or graphics to be formed on a print sheet (print medium), and print setting attribute information, which is generated based on print settings information set by the user and specifies the print settings. The print setting attribute information includes attribute information indicating functions that can be specified on the printer 102, i.e., attribute information indicating the capabilities of the printer 102, and setting values related to that attribute information.

The printer 102 performs printing on a print sheet based on the print data received from the general-purpose printing software 202. At this time, the printer 102 operates in accordance with the print setting attribute information contained in the print data, thereby forming the rendering data included in the print data on the print sheet. The print setting attribute information includes, for example, attribute information for specifying print quality (e.g., prioritizing image quality or speed), and attribute information for specifying duplex printing, simplex printing, or the like, together with setting values for such attribute information. For example, when the print setting attribute information includes attribute information specifying duplex printing, the printer 102 can perform duplex printing.

### Case Where the Extension Application is Associated

With reference to FIG. 2B, a configuration will be described in which the extension application 204 is associated with the general-purpose printing software 202 and the printer 102. As illustrated in FIG. 2B, unlike the configuration of FIG. 2A, the extension application 204 is additionally provided. That is, the host computer 101 includes the rendering application 201, the general-purpose printing software 202, and the print function information 203, and further includes the extension application 204. The extension application 204 is software for extending the functions of the general-purpose printing software 202. The extension application 204 is not pre-installed in (i.e., not bundled with) the OS. Accordingly, the extension application 204 is downloaded from a server (not illustrated) via the Internet and installed in the host computer 101 by the user operating the host computer 101. Alternatively, the extension application 204 may be automatically installed in the host computer 101 when the printer 102 is connected to the host computer 101 based on the connection. Specifically, when the printer 102 is connected to the host computer 101, the OS acquires device identification information from the printer 102. The OS may download, via the Internet, the extension application 204 corresponding to the device identification information from the server and install it. As a result, the host computer 101 holds the general-purpose printing software 202 and the extension application 204 as separate control programs. The general-purpose printing software 202 and the extension application 204 may each be updated to upgrade their versions. In such a case, the update process of the general-purpose printing software 202 and the update process of the extension application 204 may be performed at the same time or at different times. The trigger for the host computer 101 to acquire the general-purpose printing software 202 and the trigger to acquire the extension application 204 may also be the same or different. In addition, when the extension application 204 is installed, the OS associates the extension application 204 with the general-purpose printing software 202 and the printer 102.

As illustrated in FIG. 2B, the extension application 204 can exchange information (i.e., transmit and receive information) with each of the general-purpose printing software 202 and the printer 102. That is, the extension application 204 is associated with both the general-purpose printing software 202 and the printer 102. In this embodiment, the extension application 204 includes a print settings screen extension unit 205, a print function extension unit 206, an intermediate data editing unit 207, and a notification unit 209. The extension application 204 also includes shared information 208 that is accessible from each of the print settings screen extension unit 205, the print function extension unit 206, the intermediate data editing unit 207, and the notification unit 209. The shared information 208 is a file stored in the external storage 114 or information stored in the RAM 113. The extension application 204 can write to and read from the shared information 208 by using an application program interface (API) provided by the OS.

The extension application 204 may terminate its overall operation upon completion of the processing of each of the units from the print settings screen extension unit 205 to the notification unit 209. In this case, the OS launches the extension application 204 each time it receives a request to execute processing of any of the units. The OS may also terminate the overall operation of the extension application 204, for example, when the processing of the print settings screen extension unit 205 is completed. The extension application 204 may also cancel the processing of any of the units from the print settings screen extension unit 205 to the notification unit 209 during its execution. In such a case, the OS deletes the job being processed in the print queue. As described above, the rendering application 201 issues a print instruction to the OS in response to receiving a print request from the user. The rendering application 201 can also display a print settings screen. In the configuration illustrated in FIG. 2B, the rendering application 201 can display the print settings screen 300A (advanced settings screen 300C) provided by the print settings screen extension unit 205 (extension application 204). The print settings screen extension unit 205 can store advanced settings specified by the user in the shared information 208.

The intermediate data editing unit 207 acquires intermediate data from the general-purpose printing software 202. The intermediate data editing unit 207 then converts the intermediate data into print data and transmits the print data to the printer 102. The intermediate data editing unit 207 also acquires advanced setting information from the shared information 208 and adds the advanced settings to the print data. The printer 102 performs printing on a sheet based on the print data from the intermediate data editing unit 207. The extension application 204 may alternatively be configured to acquire print data generated by the general-purpose printing software 202 and add the advanced settings to the print data. In the configuration illustrated in FIG. 2B, there may also be cases where a grayscale conversion setting is not performed. In such a case, the general-purpose printing software 202 may send the print data directly to the printer 102 without passing it through the extension application 204.

The print function extension unit 206 can edit the print function information 203 (PDC) generated by the general-purpose printing software 202 or the OS. This enables the addition of functions provided by the extension application 204. It is also possible to add functions that can be performed by the printer 102 but cannot be performed by the general-purpose printing software 202 (e.g., a grayscale conversion function), as well as to add mutually exclusive relationships among setting values of print functions. The OS activates the print function extension unit 206 when the extension application 204 is first associated with the printer 102 and the general-purpose printing software 202. The OS may also activate the print function extension unit 206 at other times, such as when the OS is started. By being activated in this manner, even if functions related to printing are extended later, the print function extension unit 206 can detect the extended functions and add them to the print function information 203. Examples of functions related to printing being extended later include the addition of an optional device (such as a finisher) to the printer 102 after its installation.

The notification unit 209 can provide a notification when an error occurs in the printer 102. For example, when a paper-out error occurs in the printer 102, the general-purpose printing software 202 detects the occurrence of this error. The OS displays on the display 119 a message indicating the occurrence of the paper-out error, as detected by the general-purpose printing software 202, by using a notification function called a “toast notification,” which is a feature of the OS. When the user operates the toast notification, the notification unit 209 is invoked by the OS, causing the user interface (UI) screen of the notification unit 209 to be displayed. The user interface screen can display, for example, a detailed message about the paper-out error and instructions for refilling paper.

As described above, in this embodiment, the extension application 204 can be considered to have the following four functions. The first function is a function to display a setting screen. This function is performed by the print settings screen extension unit 205. The second function is a function to edit intermediate data, convert it into print data, and add advanced settings to the print data. This function is performed by the intermediate data editing unit 207. The third function is a function to extend the functions that can be specified by the print data generation software. This function is performed by the print function extension unit 206. The fourth function is a function to display a screen in response to the occurrence of an error in the printer 102. This function is performed by the notification unit 209. Note that the configuration of the extension application 204 is not limited to having these four functions; the extension application 204 may have a configuration with at least one function, and it may also be provided with additional functions. Additionally, once the extension application 204 has transmitted the print data to the printer 102, it cannot display any guide or the like associated with the print data during the processing of each unit.

### Examples of Print Settings Screen/Advanced Settings Screen

FIGS. 3A to 3D are diagrams each illustrating an example of a screen displayed on the display of the printing system. FIG. 3A illustrates a print settings screen displayed by the rendering application 201. FIG. 3B illustrates an advanced settings screen displayed in a configuration where the extension application 204 is not associated. FIGS. 3C and 3D illustrate advanced settings screens displayed in a configuration where the extension application 204 is associated. The units or modules that display each screen are not particularly limited. For example, the print settings screen extension unit 205 may be configured solely to generate a display screen. In such a case, the print settings screen extension unit 205 transmits the generated display screen to the rendering application 201 via the general-purpose printing software 202. The rendering application 201 may be configured to display the acquired display screen.

The print settings screen 300A illustrated in FIG. 3A is a screen that allows setting of print conditions for printing with the printer 102. The print settings screen 300A includes controls (buttons) 301, 302, 303, 304, and 305. The control 301 allows the user to set the printer 102 to be used for printing, the print orientation on the printer 102, the number of copies to be printed by the printer 102, and the output color. For example, selecting “Color (CL)” in the control 301 produces an output in which gray is represented in CMYK, while selecting “Monochrome (BW)” produces an output using only black (K). In FIG. 3A, as an example, the printer 102 to be used for printing is set to “Printer 200a,” the number of copies to be printed by the printer 102 is set to “1,” the print orientation on the printer 102 is set to “Portrait,” and the output color is set to “Auto.” The control 302 displays a preview screen. The control 303 allows the user to instruct the start of printing on the printer 102. The control 304 allows the user to instruct the cancellation of printing on the printer 102. The control 305 allows the user to perform advanced settings.

When the control 305 is operated in a configuration where the extension application 204 is not associated, the advanced settings screen 300B illustrated in FIG. 3B is displayed. The advanced settings screen 300B includes controls 306, 307, 308, and 309. The controls 306 to 308 are arranged vertically on the upper portion of the advanced settings screen 300B. The control 309 is located at the lower portion of the advanced settings screen 300B. The control 306 allows the user to select and set the type of paper used for printing by the printer 102. In FIG. 3B, as an example, “Plain Paper” is selected. The control 307 allows the user to select and set the paper size used for printing by the printer 102. In FIG. 3B, as an example, “A4” is selected. The control 308 allows the user to select the paper feed source used for printing by the printer 102. In FIG. 3B, as an example, “Auto” is selected. The control 309 allows the user to complete the settings made with the controls 306 to 308. In addition, operating the control 309 returns the display to the print settings screen 300A illustrated in FIG. 3A.

When the control 305 is pressed (operated) in a configuration where the extension application 204 is associated, the advanced settings screen (setting reception screen) 300C illustrated in FIG. 3C is displayed. While the advanced settings screen 300C is displayed together with the print settings screen 300A, its display manner is not particularly limited. For example, the advanced settings screen 300C may be displayed overlapping the print settings screen 300A, may be displayed adjacent to the print settings screen 300A, or may be displayed after the print settings screen 300A temporarily disappears. The advanced settings screen 300C is a screen capable of receiving a grayscale conversion setting. The advanced settings screen 300C includes the controls 306 to 309, as in the advanced settings screen 300B. The advanced settings screen 300C additionally includes controls 310, 312, and 313 as controls for the grayscale conversion setting. The control 310 is a setting selection section to enable or disable the grayscale conversion setting. When the control 310 is pressed, a list 311 is displayed, which includes “Enable” to indicate that the grayscale conversion setting is enabled, and “Disable” to indicate that the grayscale conversion setting is disabled. The desired option can be selected from “Enable” and “Disable.” In FIG. 3C, as an example, “Enable” is selected. The control 312 is an operation section to display the advanced settings screen (setting reception screen) 300D (see FIG. 3D) for performing detailed settings of the grayscale conversion setting. Pressing the control 312 causes the advanced settings screen 300D to be displayed. The display manner of the advanced settings screen 300D is not particularly limited. For example, the advanced settings screen 300D may be displayed overlapping the advanced settings screen 300C, may be displayed adjacent to the advanced settings screen 300C, or may be displayed after the advanced settings screen 300C temporarily disappears. The control 313 is a forced restoration section to forcibly restore the detailed settings of the grayscale conversion setting configured on the advanced settings screen 300D to an initial state. This allows, for example, the detailed settings of the grayscale conversion setting on the advanced settings screen 300D to be reconfigured.

The advanced settings screen 300D includes controls 315, 330, and 331. The control 315 is a method selection section to select a grayscale conversion method. When the control 315 is pressed, a list 316 is displayed that lists a plurality of selectable grayscale conversion methods. In this embodiment, the list 316 includes the following three conversion methods: Conversion Method 1, Conversion Method 2, and Conversion Method 3; however, it is not limited thereto. Conversion Methods 1 to 3 will be described later. In FIG. 3C, as an example, “Conversion Method 1” is selected. The control 330 allows the settings on the advanced settings screen 300D to be saved to the external storage 114 and then the screen to be closed. The control 331 allows the advanced settings screen 300D to be closed without saving the settings.

### Grayscale Conversion Methods

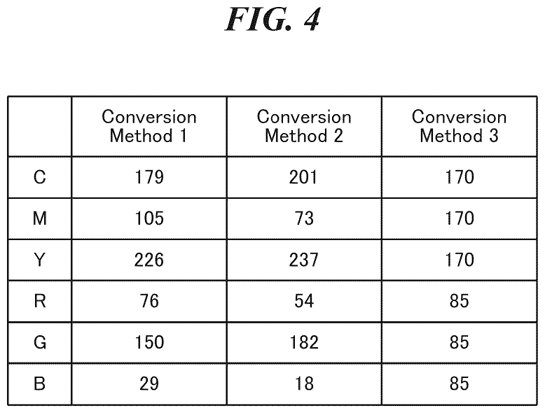

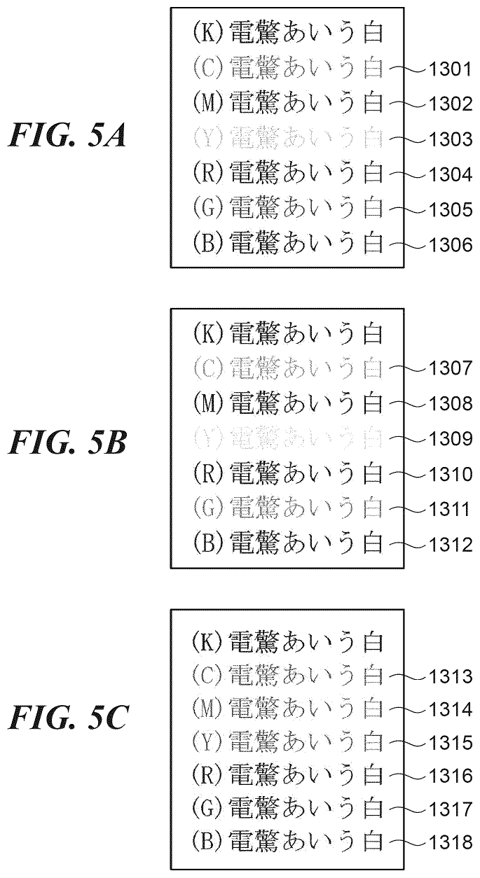

An example of the grayscale conversion methods will be described. FIG. 4 is a diagram illustrating an example of a table for explaining the effects of the grayscale conversion methods. FIGS. 5A to 5C are conceptual diagrams illustrating the effects of the grayscale conversion methods. Conversion Method 1 is represented by Equation (1), Conversion Method 2 is represented by Equation (2), and Conversion Method 3 is represented by Equation (3). Equations (1) to (3) differ from each other in the weighting coefficients used for converting from RGB to grayscale. In addition, in Equations (1) to (3), a value of “0” represents black, and a value of “255” represents white.

$$Gray 1 = Red \times 0.299 + Green \times 0.587 + Blue \times 0.114 \qquad ( 1 )$$

$$Gray 2 = Red \times 0.2126 + Green \times 0.7152 + Blue \times 0.0722 \qquad ( 2 )$$

$$Gray 3 = ( Red + Green + Blue ) / 3 \qquad ( 3 )$$

Conversion Method 1 is a general conversion method by which a gray tone corresponding to the brightness or luminance is obtained. When it is desired to emphasize a specific color, i.e., to represent it in a darker tone compared to this general conversion method, Conversion Method 2 or Conversion Method 3 is selected. For example, cyan (C) in a color image is represented as (R, G, B)=(0, 255, 255). Any one of Equations (1) to (3) can be used to convert this cyan to grayscale. When Equation (1) is used, “0” is substituted for “Red,” “255” is substituted for “Green,” and “255” is substituted for “Blue” in Equation (1). As a result, Gray1=178.75≈179 (see “C” under “Conversion Method 1” in FIG. 4). This cyan is represented by an image 1301 in FIG. 5A. When Equation (2) is used, “0” is substituted for “Red,” “255” is substituted for “Green,” and “255” is substituted for “Blue” in Equation (2). As a result, Gray2=200.73≈201 (see “C” under “Conversion Method 2” in FIG. 4). This cyan is represented by an image 1307 in FIG. 5B. When Equation (3) is used, “0” is substituted for “Red,” “255” is substituted for “Green,” and “255” is substituted for “Blue” in Equation (3). As a result, Gray3=169.98≈170 (see “C” under “Conversion Method 3” in FIG. 4). This cyan is represented by an image 1313 in FIG. 5C. Among the values obtained by Equations (1) to (3), the smaller the value, the darker (more emphasized) the cyan is represented.

Magenta (M) in a color image is represented as (R, G, B)=(255, 0, 255). Any one of Equations (1) to (3) can be used to convert this magenta to grayscale. When Equation (1) is used, “255” is substituted for “Red,” “0” is substituted for “Green,” and “255” is substituted for “Blue” in Equation (1). As a result, Gray1=105.31≈105 (see “M” under “Conversion Method 1” in FIG. 4). This magenta is represented by an image 1302 in FIG. 5A. When Equation (2) is used, “255” is substituted for “Red,” “0” is substituted for “Green,” and “255” is substituted for “Blue” in Equation (2). As a result, Gray2=72.57≈73 (see “M” under “Conversion Method 2” in FIG. 4). This magenta is represented by an image 1308 in FIG. 5B. When Equation (3) is used, “255” is substituted for “Red,” “0” is substituted for “Green,” and “255” is substituted for “Blue” in Equation (3). As a result, Gray3=169.98≈170 (see “M” under “Conversion Method 3” in FIG. 4). This magenta is represented by an image 1314 in FIG. 5C. Among the values obtained by Equations (1) to (3), the smaller the value, the darker the magenta is represented.

Yellow (Y) in a color image is represented as (R, G, B)=(255, 255, 0). Any one of Equations (1) to (3) can be used to convert this yellow to grayscale. When Equation (1) is used, “255” is substituted for “Red,” “255” is substituted for “Green,” and “0” is substituted for “Blue” in Equation (1). As a result, Gray1=225.93≈226 (see “Y” under “Conversion Method 1” in FIG. 4). This yellow is represented by an image 1303 in FIG. 5A. When Equation (2) is used, “255” is substituted for “Red,” “255” is substituted for “Green,” and “0” is substituted for “Blue” in Equation (2). As a result, Gray2=236.58≈237 (see “Y” under “Conversion Method 2” in FIG. 4). This yellow is represented by an image 1309 in FIG. 5B. When Equation (3) is used, “255” is substituted for “Red,” “255” is substituted for “Green,” and “0” is substituted for “Blue” in Equation (3). As a result, Gray3=169.98≈170 (see “Y” under “Conversion Method 3” in FIG. 4). This yellow is represented by an image 1315 in FIG. 5C. Among the values obtained by Equations (1) to (3), the smaller the value, the darker the yellow is represented.

Red (R) in a color image is represented as (R, G, B)=(255, 0, 0). Any one of Equations (1) to (3) can be used to convert this red to grayscale. When Equation (1) is used, “255” is substituted for “Red,” “0” is substituted for “Green,” and “0” is substituted for “Blue” in Equation (1). As a result, Gray1=76.25≈76 (see “R” under “Conversion Method 1” in FIG. 4). This red is represented by an image 1304 in FIG. 5A. When Equation (2) is used, “255” is substituted for “Red,” “0” is substituted for “Green,” and “0” is substituted for “Blue” in Equation (2). As a result, Gray2=54.21≈54 (see “R” under “Conversion Method 2” in FIG. 4). This red is represented by an image 1310 in FIG. 5B. When Equation (3) is used, “255” is substituted for “Red,” “0” is substituted for “Green,” and “0” is substituted for “Blue” in Equation (3). As a result, Gray3=84.998≈85 (see “R” under “Conversion Method 3” in FIG. 4). This red is represented by an image 1316 in FIG. 5C. Among the values obtained by Equations (1) to (3), the smaller the value, the darker the red is represented.

Green (G) in a color image is represented as (R, G, B)=(0, 255, 0). Any one of Equations (1) to (3) can be used to convert this green to grayscale. When Equation (1) is used, “0” is substituted for “Red,” “255” is substituted for “Green,” and “0” is substituted for “Blue” in Equation (1). As a result, Gray1=149.69≈150 (see “G” under “Conversion Method 1” in FIG. 4). This green is represented by an image 1305 in FIG. 5A. When Equation (2) is used, “0” is substituted for “Red,” “255” is substituted for “Green,” and “0” is substituted for “Blue” in Equation (2). As a result, Gray2=182.38≈182 (see “G” under “Conversion Method 2” in FIG. 4). This green is represented by an image 1311 in FIG. 5B. When Equation (3) is used, “0” is substituted for “Red,” “255” is substituted for “Green,” and “0” is substituted for “Blue” in Equation (3). As a result, Gray3=84.99≈85 (see “G” under “Conversion Method 3” in FIG. 4). This green is represented by an image 1317 in FIG. 5C. Among the values obtained by Equations (1) to (3), the smaller the value, the darker the green is represented.

Blue (B) in a color image is represented as (R, G, B)=(0, 0, 255). Any one of Equations (1) to (3) can be used to convert this blue to grayscale. When Equation (1) is used, “0” is substituted for “Red,” “0” is substituted for “Green,” and “255” is substituted for “Blue” in Equation (1). As a result, Gray1=29.07≈29 (see “B” under “Conversion Method 1” in FIG. 4). This blue is represented by an image 1306 in FIG. 5A. When Equation (2) is used, “0” is substituted for “Red,” “0” is substituted for “Green,” and “255” is substituted for “Blue” in Equation (2). As a result, Gray2=18.36≈18 (see “B” under “Conversion Method 2” in FIG. 4). This blue is represented by an image 1312 in FIG. 5B. When Equation (3) is used, “0” is substituted for “Red,” “0” is substituted for “Green,” and “255” is substituted for “Blue” in Equation (3). As a result, Gray3=84.99≈85 (see “B” under “Conversion Method 3” in FIG. 4). This blue is represented by an image 1318 in FIG. 5C. Among the values obtained by Equations (1) to (3), the smaller the value, the darker the blue is represented.

As described above, Conversion Methods 1 to 3 use different color components, that is, the ratios of the RGB color components differ among the methods. This allows the selection of an appropriate method from Conversion Methods 1 to 3 based on the color desired to be represented more darkly in the image. In this embodiment, conversion is performed into single-channel Gray data; however, the embodiment is not limited thereto. For example, gray may alternatively be represented by setting the three RGB channels to the same gray value, as in (R, G, B)=(Gray1, Gray1, Gray1). The grayscale conversion process may be performed by the CPU 111 of the host computer 101 (extension application 204) or by the CPU of the printer 102.

Incidentally, the items included in the advanced settings screen 300B illustrated in FIG. 3B differ from those included in the advanced settings screen 300C illustrated in FIG. 3C due to the following reasons. The advanced settings screens 300B and 300C are each generated based on print function information (capability information). As described above, the general-purpose printing software 202 is not capable of performing the grayscale conversion setting. In other words, the function of displaying the control 315 (method selection section) on the advanced settings screen 300C is a function that cannot be performed by the general-purpose printing software 202. Therefore, the general-purpose printing software 202 alone cannot add the grayscale conversion setting function to the print function information. Furthermore, even if the print function information originally includes the grayscale conversion setting function, the general-purpose printing software 202 cannot interpret the grayscale conversion setting function included in the print function information. Accordingly, it is not possible to display the grayscale conversion setting on the advanced settings screen. To address this, the print function extension unit 206 adds information related to the grayscale conversion setting to the print function information 203, and the print settings screen extension unit 205 refers to the capability information to display the advanced settings screen 300C. This enables the extension application 204 to display the grayscale conversion setting on the advanced settings screen.

### Flowchart of the Operation of the Print Function Extension Unit for Editing Print Function Information

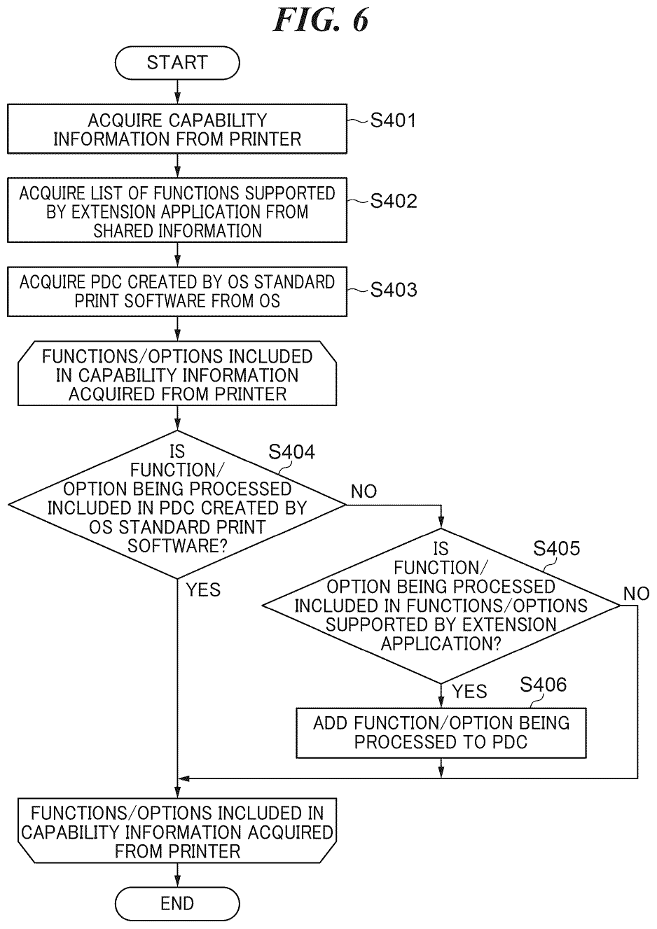

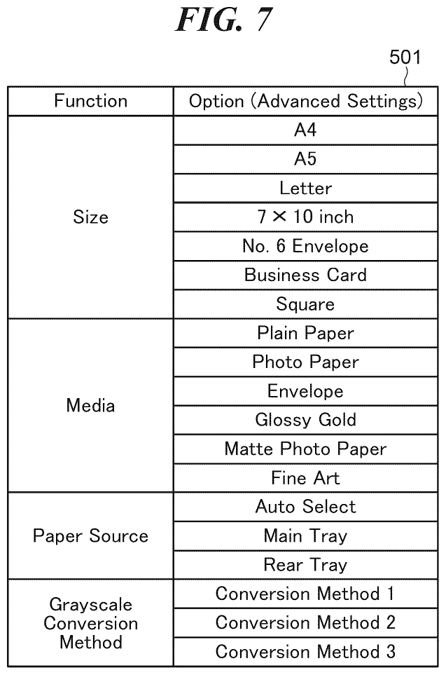

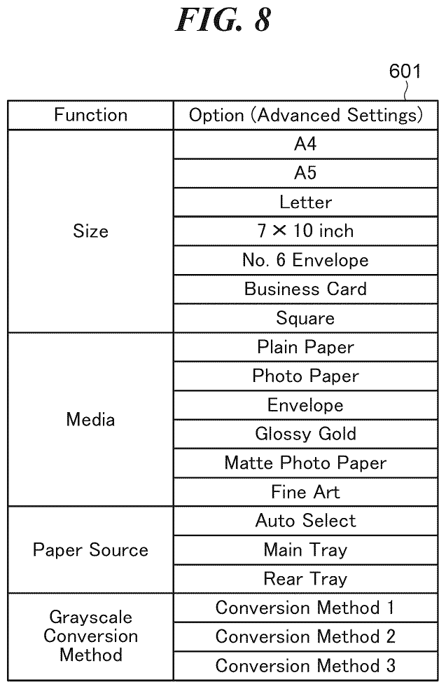

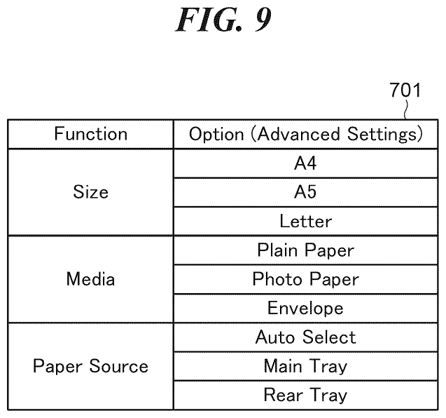

FIG. 6 is a flowchart illustrating a process in which the print function extension unit edits print function information. A computer program based on the flowchart illustrated in FIG. 6 is executed by the CPU 111, which controls the print function extension unit 206. FIG. 7 is a diagram illustrating an example of a list of capability information of the printer. FIG. 8 is a diagram illustrating an example of a list of print functions supported by the extension application. FIG. 9 is a diagram illustrating an example of a list of capability information of the general-purpose printing software. As illustrated in FIG. 6, in step S401, prior to displaying a screen, the print function extension unit 206 acquires capability information from the printer 102. The capability information is information regarding the printing capability of the printer 102. In this embodiment, the capability information corresponds to setting values included in a response obtained by issuing an IPP “Get-Printer-Attributes” operation to the printer 102. The setting values are attribute information indicating functions that can be specified on the printer 102, and information related to that attribute information. Table 501 illustrated in FIG. 7 lists the capability information of the printer 102. One example of the capability information is information regarding paper sizes used for printing by the printer 102. Other examples include information regarding paper types (media) used for printing by the printer 102, information regarding paper feed sources used for printing by the printer 102, and information regarding the grayscale conversion function that can be performed by the printer 102.

In step S402, the print function extension unit 206 acquires, from the shared information 208, the print functions supported by the extension application 204. The shared information 208 stores a list of print functions supported by the extension application 204. This list includes all print functions that the extension application 204 can handle, along with their setting values. Table 601 illustrated in FIG. 8 includes, as a print function, information regarding paper sizes supported by the extension application 204. Other examples include information regarding paper types supported by the extension application 204, information regarding paper feed sources supported by the extension application 204, and information regarding the grayscale conversion function supported by the extension application 204. In addition, the print functions supported by the extension application 204 may be updated, for example, through updates to the extension application 204.

In step S403, the print function extension unit 206 acquires the print function information 203 created by the general-purpose printing software 202 from the OS. The print function information 203 is created based on the capability information acquired by the general-purpose printing software 202 from the printer 102 (see Table 501). The print function information 203 (PDC) created by the general-purpose printing software 202 includes only the print functions supported by the general-purpose printing software 202 from the capability information acquired from the printer 102. For example, while Table 601 illustrated in FIG. 8 includes paper sizes such as “7×10 inches” and “No. 6 envelope” (a Japanese envelope size), Table 701 illustrated in FIG. 9 indicates that the general-purpose printing software 202 does not support these paper sizes. Therefore, the corresponding paper sizes are not included in the print function information 203. Similarly, Table 601 illustrated in FIG. 8 includes information regarding the grayscale conversion function; however, Table 701 illustrated in FIG. 9 indicates that the general-purpose printing software 202 does not support the grayscale conversion function. Accordingly, the grayscale conversion function is not included in the print function information 203. By adding functions or options to the print function information 203, the print function extension unit 206 enables the extension application 204 to compensate for the functional limitations of the general-purpose printing software 202. In addition, the print function extension unit 206 can also remove unnecessary functions or options from the print function information 203 created by the general-purpose printing software 202.

Steps S404, S405, and S406 are processes repeatedly performed for the list of functions included in the capability information acquired from the printer 102 in step S401. In this embodiment, steps S404, S405, and S406 are repeatedly performed for all 19 options included in Table 501.

In step S404, the print function extension unit 206 determines whether the function or option currently being processed is included in the print function information 203 generated by the general-purpose printing software 202. If it is determined in step S404 that the function or option is included in the print function information 203, the process ends if the option being processed is the last one. If the option being processed is not the last one, then the next option is selected to perform step S404 again. On the other hand, if it is determined in step S404 that the function or option is not included in the print function information 203, the process proceeds to step S405. For example, in this embodiment, Table 501 includes the paper size “A4,” and Table 701 also includes the paper size “A4.” In this case, it is determined in step S404 that the function or option currently being processed is included in the print function information 203. In contrast, while Table 501 includes the “grayscale conversion method,” Table 701 does not. In this case, it is determined in step S404 that the function or option currently being processed is not included in the print function information 203.

In step S405, the print function extension unit 206 determines whether the function (option) currently being processed is included in the functions (options) supported by the extension application 204. If it is determined in step S405 that the function currently being processed is included, the process proceeds to step S406. On the other hand, if it is determined in step S405 that the function currently being processed is not included, the process ends if the option being processed is the last one, in the same manner as when the determination result is “Yes” in step S404. If the option being processed is not the last one, then the next option is selected to perform step S404 again. For example, in this embodiment, when the function currently being processed is the “grayscale conversion function,” the corresponding “grayscale conversion function (grayscale conversion method)” exists in Table 601. Therefore, in step S405, it is determined that the function currently being processed is included.

In step S406, the print function extension unit 206 adds the function (option) currently being processed to the print function information 203. Upon completion of step S406, the process ends if the option being processed is the last one, in the same manner as when the determination result is “Yes” in step S404. If the option being processed is not the last one, then the next option is selected to perform step S404 again.

As described above, the extension application 204 can add functions (options) that are not supported by the general-purpose printing software 202, but are supported by the printer 102 and by the extension application 204, to the print function information 203. Capability information (PC) is generated based on the print function information 203 edited through this addition process. The print settings screen extension unit 205 can then generate a display screen based on this capability information, thereby supplementing the functions not supported by the general-purpose printing software 202 and displaying the advanced settings screen 300C.

### Processes After the Rendering Application Receives Print Settings

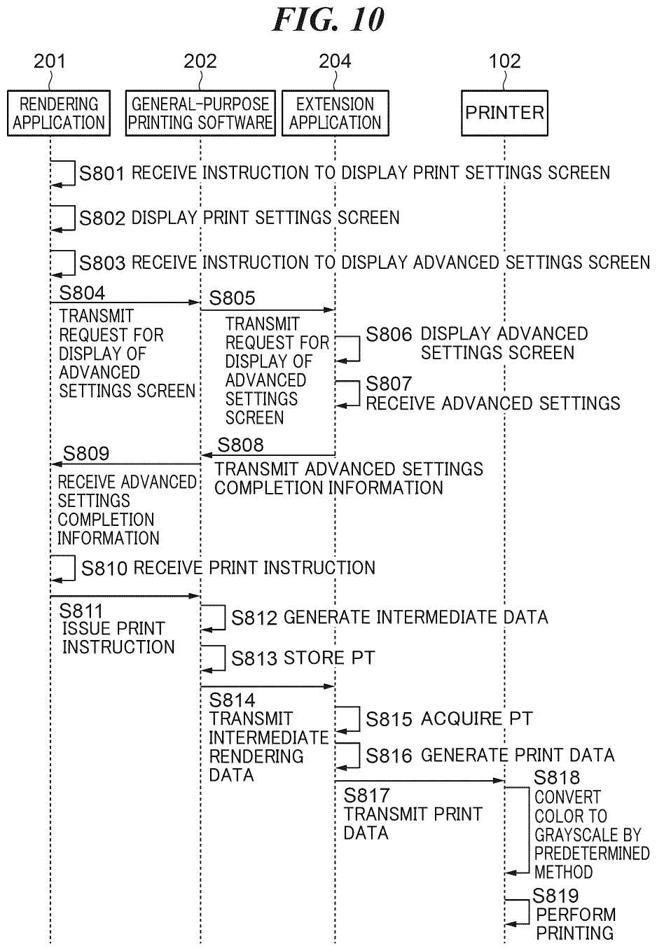

FIG. 10 is a sequence diagram illustrating processes performed among the rendering application, the general-purpose printing software, the extension application, and the printer after the rendering application receives print settings. The operations of the rendering application, the general-purpose printing software, and the extension application are implemented by the CPU 111 of the host computer 101. The program for these processes is stored in the external storage 114. The CPU 111 loads the program from the external storage 114 into the RAM 113 and executes it. The operation of the printer 102 is implemented by the CPU (not illustrated) of the printer 102. The printing system 1000 has a software configuration as illustrated in FIG. 2B.

As illustrated in FIG. 10, in step S801, the rendering application 201 receives an instruction to display a print settings screen from the user. For example, the user can use the pointing device 117 or the keyboard 118 to instruct the rendering application 201 to display a print settings screen.

In step S802, the rendering application 201 displays the print settings screen 300A illustrated in FIG. 3A on the display 119.

In step S803, the rendering application 201 receives an instruction to display an advanced settings screen from the user. For example, the user can use the pointing device 117 or the keyboard 118 to select the control 305 on the print settings screen 300A, thereby instructing to display an advanced settings screen.

In step S804, the rendering application 201 transmits a request for display of an advanced settings screen to the general-purpose printing software 202.

In step S805, the general-purpose printing software 202 transmits a request for display of an advanced settings screen to the extension application 204.

In step S806, the print settings screen extension unit 205 of the extension application 204 displays the advanced settings screen 300C illustrated in FIG. 3C. As described above, the print function extension unit 206 adds a grayscale conversion setting (grayscale conversion method) to the print function information 203 (PDC). The print settings screen extension unit 205 can display the advanced settings screen 300C by referring to the capability information (PC) generated based on the print function information 203 with the added setting.

In step S807, the print settings screen extension unit 205 receives detailed or advanced settings made by the user on the advanced settings screen 300C. As an example, it is assumed that “Plain Paper” is selected as the paper type through the control 306, “A4” is selected as the paper size through the control 307, “Auto” is selected for the paper feed source through the control 308 on the advanced settings screen 300C (see FIG. 3C). Additionally, “Enable” is selected for the grayscale conversion through the control 310 (see FIG. 3C). In this setting state (selection state), when the print settings screen extension unit 205 receives the user's operation of the control 309 on the advanced settings screen 300C, the advanced settings screen 300D illustrated in FIG. 3D is displayed. The print settings screen extension unit 205 then receives advanced settings made by the user on the advanced settings screen 300D. As one example, it is assumed that “Conversion Method 1” is selected as the grayscale conversion method through the control 315 on the advanced settings screen 300D. In this setting state, when the print settings screen extension unit 205 receives the user's operation of the control 330 on the advanced settings screen 300D, the advanced settings are completed. For example, the user can use the pointing device 117 or the keyboard 118 to select the control 330, thereby instructing the completion of the advanced settings.

In step S808, the extension application 204 transmits advanced settings completion information, indicating the completion of the advanced settings in step S807, to the general-purpose printing software 202.

In step S809, the general-purpose printing software 202 receives the advanced settings completion information transmitted from the extension application 204 in step S808. The general-purpose printing software 202 then transmits this advanced settings completion information to the rendering application 201.

In step S810, the rendering application 201 receives a print instruction from the user. For example, the user can use the pointing device 117 or the keyboard 118 to select the control 303 on the print settings screen 300A (see FIG. 3A), thereby issuing a print instruction.

In step S811, the rendering application 201 issues the print instruction received in step S810 to the general-purpose printing software 202.

In step S812, the general-purpose printing software 202 uses an OS module to generate intermediate data based on the print instruction issued in step S811.

In step S813, the general-purpose printing software 202 stores print settings information (PT) based on the print instruction issued in step S811 in the shared information 208.

In step S814, the general-purpose printing software 202 transmits rendering data (image data), which is part of the intermediate data generated in step S812, to the extension application 204.

In step S815, the intermediate data editing unit 207 of the extension application 204 acquires the print settings information stored in step S813 from the shared information 208.

In step S816, the intermediate data editing unit 207 of the extension application 204 generates print data using the rendering data transmitted in step S814 and the print settings information acquired in step S815. This print data includes, as the grayscale conversion method, “Conversion Method 1” received in step S807.

In step S817, the intermediate data editing unit 207 of the extension application 204 transmits the print data generated in step S816 to the printer 102. As described above, the print data includes the grayscale conversion method “Conversion Method 1” received in step S807. This transmission makes it possible to instruct the printer 102 to perform printing with grayscale conversion based on Conversion Method 1.

In step S818, the printer 102 receives the print data transmitted in step S817. The printer 102 interprets the print data and performs the necessary image processing on the print data. In this case, the image processing involves performing a grayscale conversion on the print data using Conversion Method 1 (a predetermined conversion method).

In step S819, the printer 102 prints the print data on which the image processing has been performed in step S818. As a result, the print data that has undergone grayscale conversion is output as a print.

As described above, in the printing system 1000, even when the general-purpose printing software 202 does not support the grayscale conversion setting, the extension application 204 can display the advanced settings screen 300C illustrated in FIG. 3C. Through the advanced settings screen 300C, the printer 102 can be instructed to perform grayscale conversion. As a result, grayscale conversion is performed using, for example, a conversion method selected from Conversion Methods 1 to 3, and the print output from the printer 102 exhibits a grayscale image with a color tone adjusted as desired. In this embodiment, the grayscale conversion method may be specified according to attributes such as text, graphics, and the like.

In the description with reference to FIG. 10, it is assumed that the printing system 1000 has a software configuration as illustrated in FIG. 2B, and the advanced settings screen 300C illustrated in FIG. 3C is displayed; however, the embodiment is not limited thereto. For example, when a request is issued to the general-purpose printing software 202 to display an advanced settings screen in step S804, the general-purpose printing software 202 may display the advanced settings screen 300B illustrated in FIG. 3B. In this case, after the control 309 is operated on the advanced settings screen 300B, the general-purpose printing software 202 requests the extension application 204 to display an additional advanced settings screen. Subsequently, the extension application 204 may additionally display an advanced settings screen that allows a line thickness adjustment setting. Furthermore, in this embodiment, the extension application 204 generates print data from the intermediate data created by the general-purpose printing software 202; however, the embodiment is not limited thereto. For example, the extension application 204 itself may generate the intermediate data.

### Second Embodiment

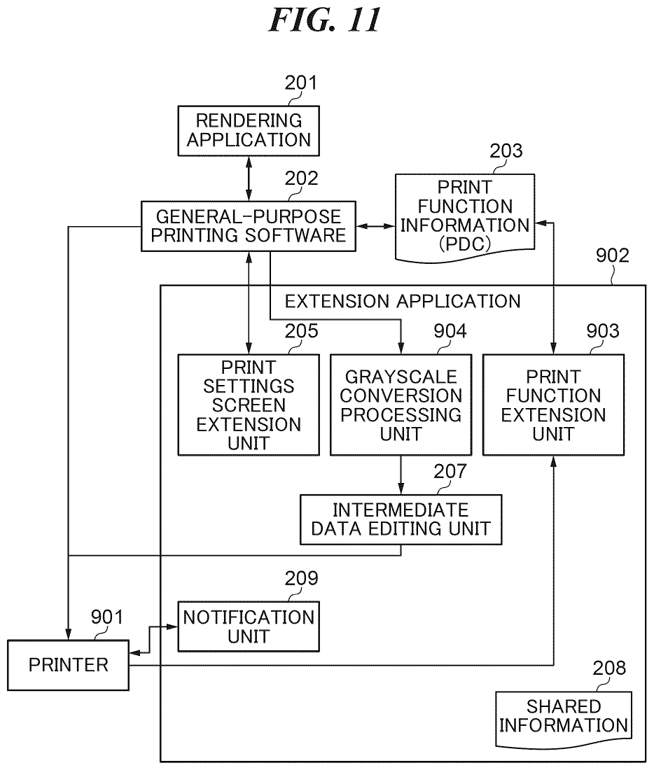

A second embodiment will be described below with reference to FIGS. 11 to 13, focusing on the differences from the previously described embodiment without repeating the same explanations. In the first embodiment, the extension application 204 generates print data including a grayscale conversion setting together with the general-purpose printing software 202. This print data is transmitted to the printer 102. The printer 102 can interpret the print data including the grayscale conversion setting and perform grayscale conversion. In this manner, in the first embodiment, the extension application 204, in conjunction with the general-purpose printing software 202, causes the printer 102 to perform grayscale conversion.

However, some printers (102) may be incapable of performing grayscale conversion. In such a case, even if the extension application 204 generates print data that includes a grayscale conversion setting, it cannot cause the printer 102 to perform grayscale conversion. When the printer 102 is incapable of performing grayscale conversion, the extension application 204 may generate print data with grayscale conversion already applied and send it to the printer 102.

Accordingly, in this embodiment, it is determined whether the printer 102 can perform grayscale conversion based on the capability information of the printer 102. If it is determined that the printer 102 can perform grayscale conversion, the extension application 204 generates print data including a grayscale conversion setting and transmits it to the printer 102. On the other hand, if it is determined that the printer 102 cannot perform grayscale conversion, the extension application 204 generates print data, in which grayscale conversion has already been performed on the rendering data, and transmits it to the printer 102. This allows grayscale conversion to be offered to the user even if the printer 102 is incapable of performing the grayscale conversion. Note that the second embodiment is basically similar to the first embodiment, except for differences in the configuration of the printing system 1000 when the extension application 204 is associated, the PDC editing process, and the processes after the rendering application 201 receives print settings.

### Software-Centric Configuration of the Printing System

FIG. 11 is a block diagram illustrating an example of the software configuration of the printing system according to the second embodiment. The block diagram in FIG. 11 illustrates a configuration in which an extension application 902 is associated with the general-purpose printing software 202 and a printer 901. As illustrated in FIG. 11, the host computer 101 includes the rendering application 201, the general-purpose printing software 202, the print function information 203, and the extension application 902. The extension application 902 is communicatively connected to the printer 901. Unlike the printer 102 of the first embodiment, the printer 901 is a printer that is incapable of performing grayscale conversion. The extension application 902 includes the print settings screen extension unit 205, the intermediate data editing unit 207, the shared information 208, the notification unit 209, a print function extension unit 903, and a grayscale conversion processing unit 904. The print function extension unit 903 can add information related to grayscale conversion to the print function information 203 even when it is determined that the printer 901 cannot perform grayscale conversion based on the capability information acquired from the printer 901. The grayscale conversion processing unit 904 performs grayscale conversion on the intermediate data received from the general-purpose printing software 202 based on a grayscale conversion setting.

### Flowchart of the Operation of the Print Function Extension Unit for Editing Print Function Information

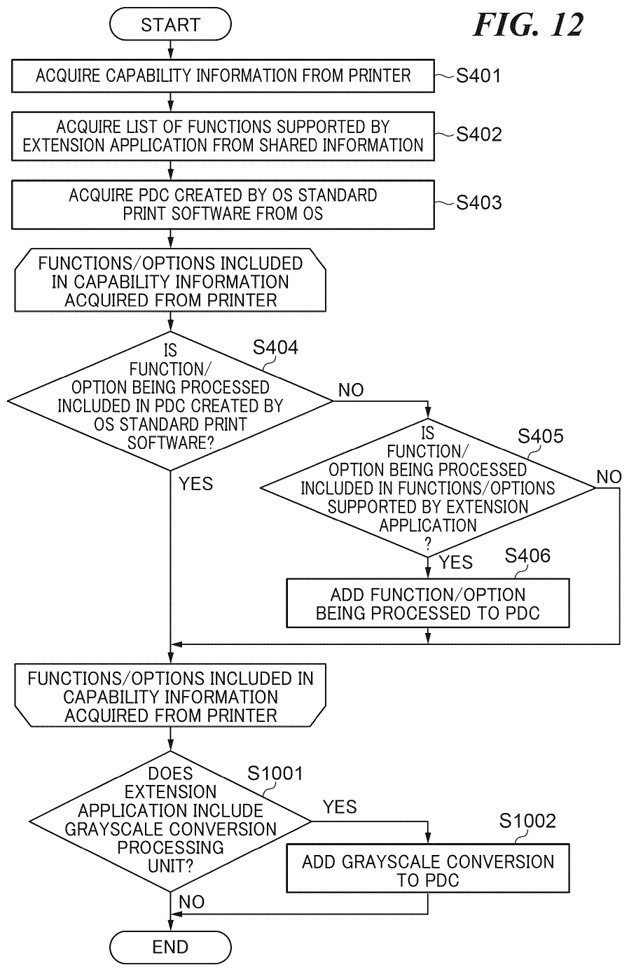

FIG. 12 is a flowchart illustrating a process in which the print function extension unit edits print function information. A computer program based on the flowchart illustrated in FIG. 12 is executed by the CPU 111 controlling the print function extension unit 903. The flowchart illustrated in FIG. 12 further includes steps S1001 and S1002 in addition to the flowchart illustrated in FIG. 6. As illustrated in FIG. 12, when the repetition of steps S404 to S406 is completed, the process proceeds to step S1001. As described above, the printer is incapable of performing grayscale conversion. Therefore, after steps S404 to S406 are completed, grayscale conversion is not added to the print function information 203.

As illustrated in FIG. 12, in step S1001, the print function extension unit 903 determines whether the extension application 902 includes the grayscale conversion processing unit 904, i.e., whether the grayscale conversion processing unit 904 is present. If it is determined in step S1001 that the grayscale conversion processing unit 904 is present, the process proceeds to step S1002. On the other hand, if it is determined in step S1001 that the grayscale conversion processing unit 904 is not present, the process ends. As described above, since the extension application 902 includes the grayscale conversion processing unit 904, the process proceeds to step S1002.

In step S1002, the print function extension unit 903 adds information related to grayscale conversion and grayscale conversion methods (Conversion Methods 1 to 3) to the print function information 203.

As described above, the extension application 902 can add functions (options) that are not supported by the general-purpose printing software 202, but are supported by the printer 901 and by the extension application 902, to the print function information 203. Additionally, the extension application 902 determines whether the grayscale conversion processing unit 904 is present. If it is determined that the grayscale conversion processing unit 904 is present, grayscale conversion is added to the print function information 203. As a result of this addition process, capability information is generated based on the print function information 203 to which grayscale conversion has been added, even if the printer 901 is incapable of performing grayscale conversion. The extension application 902 can display the advanced settings screen 300C illustrated in FIG. 3C by generating a display screen based on this capability information.

### Processes After the Rendering Application Receives Print Settings

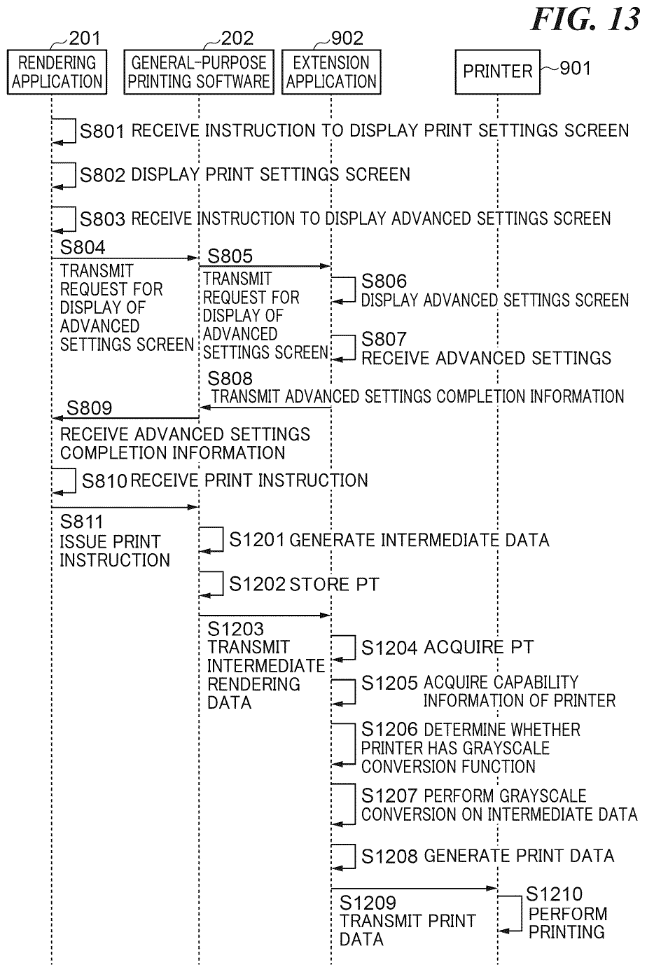

FIG. 13 is a sequence diagram illustrating processes performed among the rendering application, the general-purpose printing software, the extension application, and the printer after the rendering application receives print settings. The sequence diagram illustrated in FIG. 13 differs from the sequence diagram illustrated in FIG. 10 in that steps S1201 to S1210 are performed in sequence in place of steps S812 to S819. As illustrated in FIG. 13, after step S811 is completed, the process proceeds to step S1201.

In step S1201, the general-purpose printing software 202 uses an OS module to generate intermediate data based on the print instruction issued in step S811.

In step S1202, the general-purpose printing software 202 stores print settings information based on the print instruction issued in step S811 in the shared information 208.

In step S1203, the general-purpose printing software 202 transmits rendering data, which is part of the intermediate data generated in step S1201, to the extension application 902.

In step S1204, the grayscale conversion processing unit 904 of the extension application 902 acquires the print settings information stored in step S1202 from the shared information 208. In addition, the grayscale conversion processing unit 904 acquires information related to a grayscale conversion setting from the print settings information.

In step S1205, the grayscale conversion processing unit 904 acquires capability information of the printer 901 from the shared information 208. If the capability information of the printer 901 is not stored in the shared information 208, the print function extension unit 903 can request the capability information from the printer 901 and store it in the shared information 208.

In step S1206, the grayscale conversion processing unit 904 determines whether the printer 901 has a grayscale conversion function based on the capability information acquired in step S1205. In this embodiment, the printer 901 does not have a grayscale conversion function. Therefore, in step S1206, it is determined that the printer 901 does not have the grayscale conversion function. If it is determined in step S1206 that the printer 901 has the grayscale conversion function, the process skips step S1207 and proceeds to step S1208. In this case, the printer 901 is instructed to perform grayscale conversion. This grayscale conversion is performed based on the grayscale conversion setting received through the advanced settings screen 300C or 300D.

In step S1207, the grayscale conversion processing unit 904 performs grayscale conversion on the print data based on the information related to the grayscale conversion setting acquired in step S1204. The print data that has undergone grayscale conversion is stored in the shared information 208. In addition, the grayscale conversion processing unit 904 either edits the grayscale conversion setting in the print settings information to “0” or deletes the grayscale conversion setting from the print settings information.

In step S1208, the intermediate data editing unit 207 generates printable print data. This print data is generated using the print data that has undergone grayscale conversion, stored in the shared information 208 in step S1207, and the print settings information acquired in step S1204.

In step S1209, the intermediate data editing unit 207 of the extension application 902 transmits the print data generated in step S1208 to the printer 901.

In step S1210, the printer 901 interprets the print data transmitted in step S1209, performs the necessary image processing on the print data, and then prints it. As a result, the print data that has undergone grayscale conversion is output as a print.

### Third Embodiment

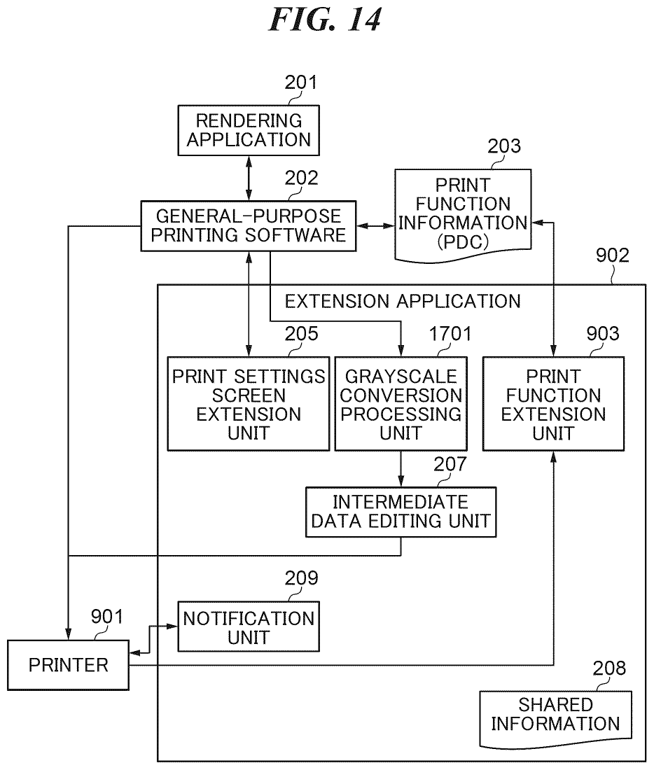

A third embodiment will be described below with reference to FIGS. 14 to 20, focusing on the differences from the previously described embodiments without repeating the same explanations. There are various types of grayscale conversion. Examples of these various types of grayscale conversion include image processing that, when converting a color image to a grayscale image, darkens relatively light-colored objects contained in the image, and image processing for distinguishing objects. The objects are not particularly limited and may include, for example, text, graphics, images, and the like. For instance, one method of darkening a relatively light gray is to increase its density through gamma processing after converting a color image to a grayscale image (hereinafter referred to as “darken”). Another method is to set all colored objects to solid black (RGB=0, 0, 0), thereby increasing the density (hereinafter referred to as “convert to solid black”). Examples of methods for distinguishing objects include emphasizing differences in gray density (hereinafter referred to as “distinguish by density”) or emphasizing the boundaries, i.e., edges, of the objects (hereinafter referred to as “distinguish by edge”). Other examples include a color conversion method in which, after a color image is converted to a grayscale image, the image is output using only the K plate when converting to the color plates available in the printer 901, or a color conversion method in which a plurality of color plates, such as the CMY plates, are combined to represent gray for output. Among printers (901), some are capable of performing all of these processes, while others can perform only part of them. In this embodiment, the image processing for converting a color image to a grayscale image is performed by the extension application 902, and the subsequent image processing for converting the image to color plates is performed by the printer 901.

### Software-Centric Configuration of the Printing System

FIG. 14 is a block diagram illustrating an example of the software configuration of the printing system according to the third embodiment. The block diagram in FIG. 14 illustrates a configuration in which the extension application 902 is associated with the general-purpose printing software 202 and the printer 901. As illustrated in FIG. 14, the extension application 902 includes the print settings screen extension unit 205, the intermediate data editing unit 207, the shared information 208, the notification unit 209, and the print function extension unit 903. The extension application 902 also includes a grayscale conversion processing unit 1701. The processes performed by the grayscale conversion processing unit 1701 will be described later.

### Flowchart of the Operation of the Print Function Extension Unit for Editing Print Function Information

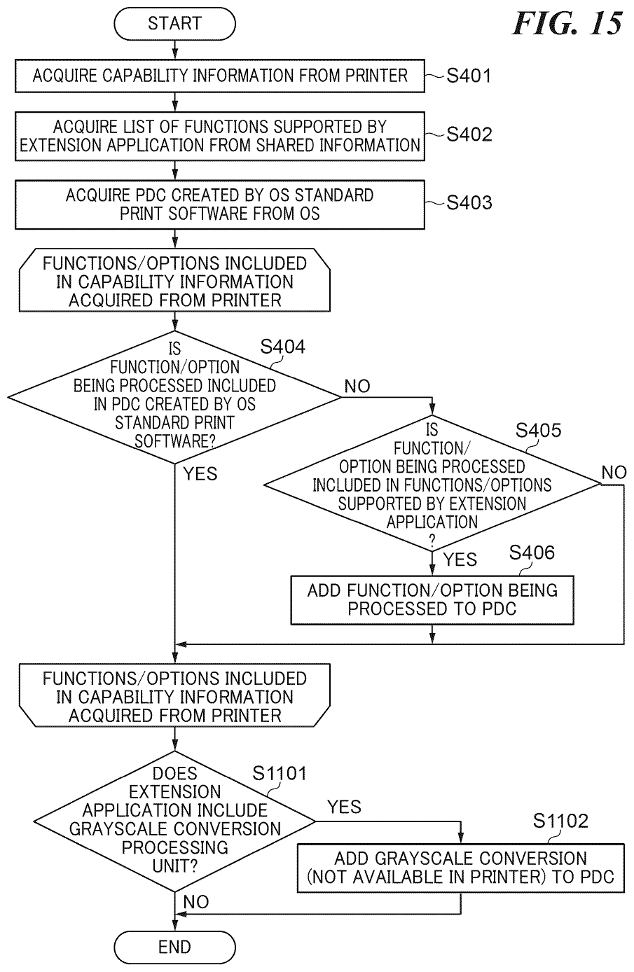

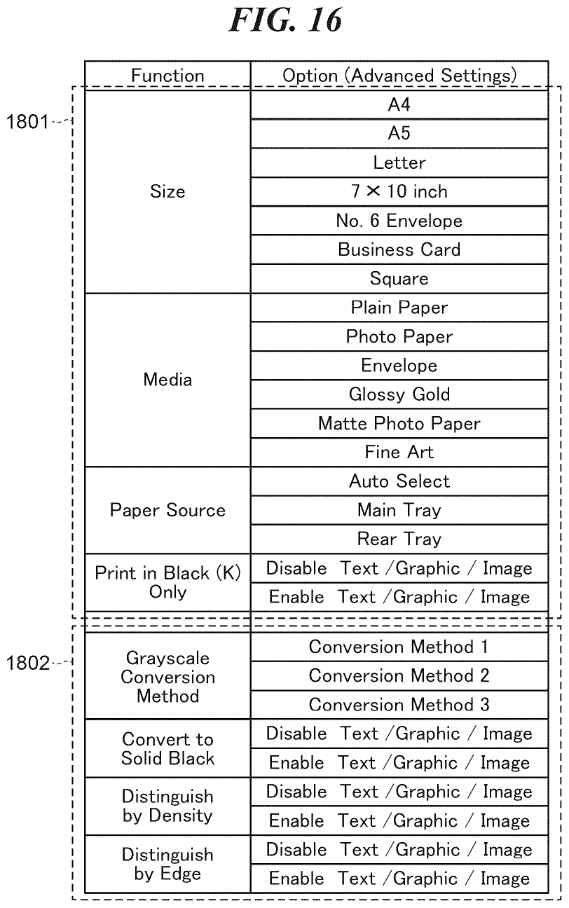

FIG. 15 is a flowchart illustrating a process in which the print function extension unit edits print function information. FIG. 16 is a diagram illustrating an example of a list of capability information. As illustrated in Table 1801 in FIG. 16, the printer 901 can perform only one type of grayscale conversion process, namely print in black (K) only. The flowchart in FIG. 15 illustrates the case where the printer 901 can perform only one type of grayscale conversion process: print in black (K) only. In FIG. 15, when the repetition of steps S404 to S406 is completed, the function “print in black (K) only,” which can be performed by the printer 901, has been added to the print function information 203. Note that the functions that can be performed by the grayscale conversion processing unit 1701, including “grayscale conversion methods,” “darken,” “convert to solid black,” “distinguish by density,” and “distinguish by edge,” have not been added to the print function information 203. After the repetition of steps S404 to S406 is completed, the process proceeds to step S1101. In step S1101, the print function extension unit 903 determines whether the extension application 902 includes the grayscale conversion processing unit 1701. If it is determined in step S1101 that the grayscale conversion processing unit 1701 is present, the process proceeds to step S1102. On the other hand, if it is determined in step S1101 that the grayscale conversion processing unit 1701 is not present, the process ends. As described above, since the extension application 902 includes the grayscale conversion processing unit 1701, the process proceeds to step S1102.

In step S1102, the print function extension unit 903 adds, to the print function information 203, the grayscale conversion processes that can be performed by the grayscale conversion processing unit 1701. As illustrated in Table 1802 in FIG. 16, the grayscale conversion processes added include “grayscale conversion methods,” “darken,” “convert to solid black,” “distinguish by density,” and “distinguish by edge.”

As described above, the print function extension unit 903 can add, to the print function information 203, functions that are not supported by the general-purpose printing software 202 but are supported by the printer 901. Thereafter, it is determined whether the extension application 902 includes the grayscale conversion processing unit 1701. If it is determined that the grayscale conversion processing unit 1701 is present, the functions such as “grayscale conversion methods,” “darken,” “convert to solid black,” “distinguish by density,” and “distinguish by edge” are added to the print function information 203. As a result, the print settings screen extension unit 205 can display on the screen the grayscale conversion processes that can be performed by the printer 901 and the grayscale conversion processing unit 1701, based on the capability information (PC) generated from the print function information 203.

Grayscale Conversion Processes Other than Grayscale Conversion Methods

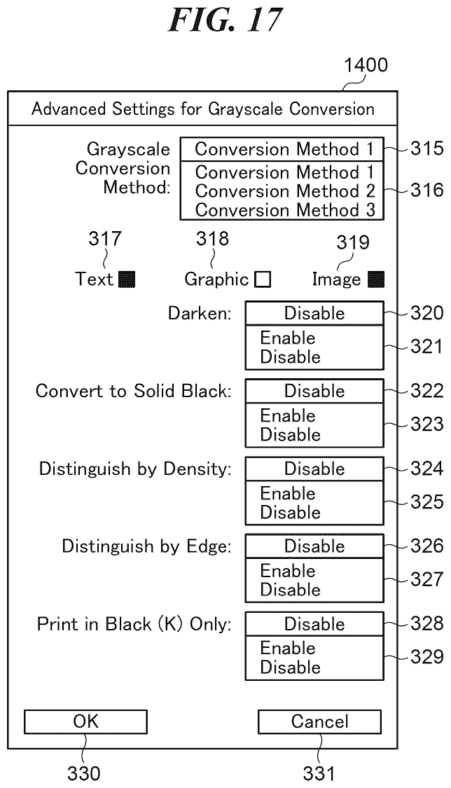

FIG. 17 is a diagram illustrating an example of a screen displayed on the display of the printing system. As illustrated in FIG. 17, an advanced settings screen 1400 includes the controls 315, 330, and 331, similar to the advanced settings screen 300D. The advanced settings screen 1400 further includes checkboxes (element selection sections) 317 to 319 and controls 320, 322, 324, 326, and 328. When the checkbox 317 is checked, the grayscale conversion processing target is set (selected) to “text.” When the checkbox 318 is checked, the grayscale conversion processing target is set to “graphics.” When the checkbox 319 is checked, the grayscale conversion processing target is set to “image.”

The control 320 is an instruction section for instructing to perform the “darken” process as a grayscale conversion process, i.e., a density adjustment section for instructing the adjustment of the density of a grayscale image. By pressing the control 320, a list (setting selection section) 321 is displayed, which includes “Enable” to indicate that the “darken” process is enabled, and “Disable” to indicate that the “darken” process is disabled. A desired option can then be selected from “Enable” or “Disable.” FIG. 17 illustrates, as an example, a state in which “Disable” is selected. The control 322 is an instruction section for instructing to perform the “convert to solid black” process as a grayscale conversion process, i.e., a black representation section for instructing the representation of a grayscale image using a black color material. By pressing the control 322, a list 323 is displayed, which includes “Enable” to indicate that the “convert to solid black” process is enabled, and “Disable” to indicate that the “convert to solid black” process is disabled. A desired option can then be selected from “Enable” or “Disable.” FIG. 17 illustrates, as an example, a state in which “Disable” is selected.

The control 324 is an instruction section for instructing to perform the “distinguish by density” process as a grayscale conversion process, i.e., a density enhancement section for instructing the enhancement of gradation differences in a grayscale image. By pressing the control 324, a list 325 is displayed, which includes “Enable” to indicate that the “distinguish by density” process is enabled, and “Disable” to indicate that the “distinguish by density” process is disabled. A desired option can then be selected from “Enable” or “Disable.” FIG. 17 illustrates, as an example, a state in which “Disable” is selected. The control 326 is an instruction section for instructing to perform the “distinguish by edge” process as a grayscale conversion process, i.e., an edge enhancement section for instructing the enhancement of contours of objects (components) constituting a grayscale image. By pressing the control 326, a list 327 is displayed, which includes “Enable” to indicate that the “distinguish by edge” process is enabled, and “Disable” to indicate that the “distinguish by edge” process is disabled. A desired option can then be selected from “Enable” or “Disable.” FIG. 17 illustrates, as an example, a state in which “Disable” is selected.

The control 328 is an instruction section for instructing to perform the “print in black (K) only” process as a grayscale conversion process. By pressing the control 328, a list 329 is displayed, which includes “Enable” to indicate that the “print in black (K) only” process is enabled, and “Disable” to indicate that the “print in black (K) only” process is disabled. A desired option can then be selected from “Enable” or “Disable.” FIG. 17 illustrates, as an example, a state in which “Disable” is selected. In this embodiment, the advanced settings screen 1400 includes the controls 320, 322, 324, 326, and 328; however, it is not limited thereto. The advanced settings screen 1400 may include at least one of these controls (settings). In addition, the advanced settings screen 1400 may include, as another control, a black representation section for instructing the representation of a grayscale image in black using a plurality of color materials. This allows the selection of whether to use any of the CMYK color components or only the K color component (control 322) to represent black. By selecting one of these options, it is possible, for example, to prevent a specific color from becoming faded when a color image is converted into a grayscale image.

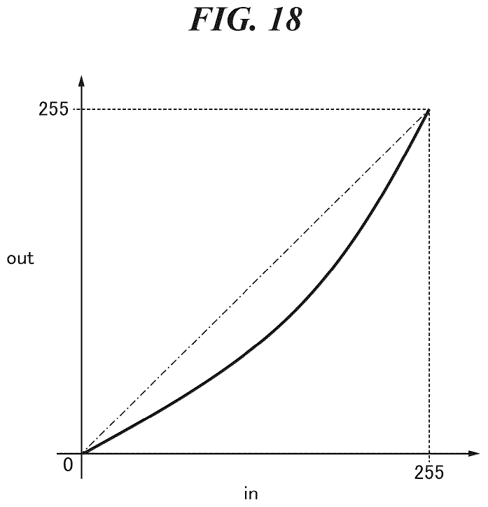

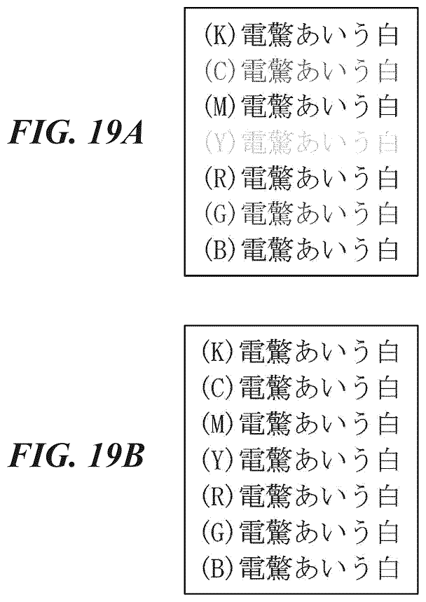

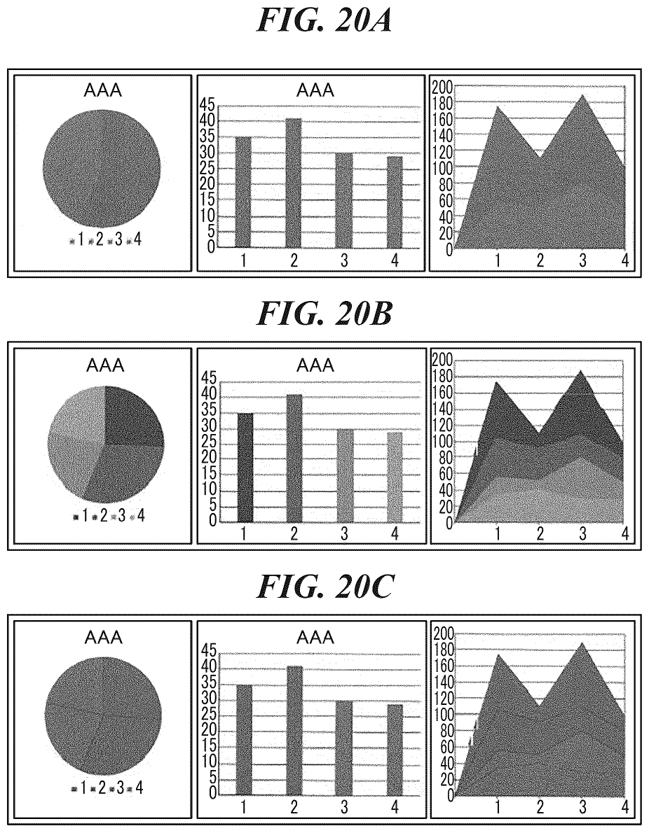

The grayscale conversion processes other than the grayscale conversion methods will now be described. FIG. 18 is a graph illustrating an example of a lookup table (LUT) used in the “darken” process. FIGS. 19A and 19B are conceptual diagrams illustrating the effects of gray conversion processes other than the grayscale conversion methods. FIGS. 20A to 20C are conceptual diagrams illustrating the effects of the “distinguishing” processes. The “darken” process involves applying a convex-downward LUT, as illustrated in FIG. 18, to an input image after conversion from color to grayscale. As a result, for example, the image illustrated in FIG. 5A becomes the image illustrated in FIG. 19A. In the image illustrated in FIG. 19A, compared with the image illustrated in FIG. 5A, the characters in each color (cyan, magenta, yellow, red, green, and blue) are overall darker. The “convert to solid black” process involves setting Gray to 0 (Gray=0) at the time of conversion from color to grayscale. As a result, for example, the image illustrated in FIG. 5A becomes the image illustrated in FIG. 19B. In the image illustrated in FIG. 19B, the characters in each color (cyan, magenta, yellow, red, green, and blue) become black.

The “distinguish by density” process is a process in which, at the time of conversion from color to grayscale, the gray values within a page are sorted and their intervals are widened, thereby enlarging the density differences. As a result, the image illustrated in FIG. 20A becomes the image illustrated in FIG. 20B. In the image illustrated in FIG. 20B, compared with the image illustrated in FIG. 20A, objects are more distinguishable from each other. The “distinguish by edge” process involves emphasizing the edges of portions where different colors are adjacent in a page, prior to conversion from color to grayscale. As a result, the image illustrated in FIG. 20A becomes the image illustrated in FIG. 20C. In the image illustrated in FIG. 20C, compared with the image illustrated in FIG. 20A, the boundaries of each object are emphasized, making the objects more distinguishable. The “print in black (K) only” process involves outputting (representing) gray using black (K) instead of representing gray with CMYK, after conversion from color to grayscale. For example, when the checkbox 317 on the advanced settings screen 1400 (see FIG. 17) is checked, text can be output using only the K plate. As a result, it is possible to prevent CMY colors from appearing at the edges of characters due to color misregistration or the like, thereby enabling clear text representation in grayscale. In addition, when the checkbox 319 on the advanced settings screen 1400 is checked and “Disable” is selected in the list 329, images can be represented using CMY. Such images appear deeper and smoother compared with those represented with only the K plate.

### Processes After the Rendering Application Receives Print Settings

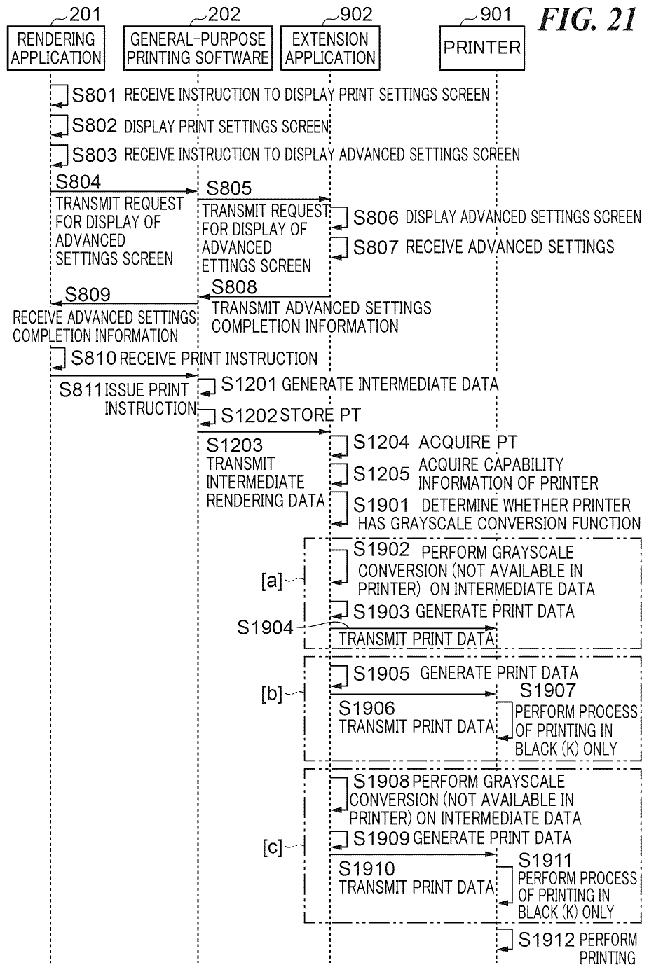

FIG. 21 is a sequence diagram illustrating processes performed among the rendering application, the general-purpose printing software, the extension application, and the printer after the rendering application receives print settings. The sequence diagram illustrated in FIG. 21 differs from the sequence diagram illustrated in FIG. 13 in that stepsS1901 to S1912 are performed in place of steps S1206 to S1210. According to the advanced settings received in step S807, the process is divided into three sequences. The first sequence is performed when the image processing by the grayscale conversion processing unit 1701 is selected in the advanced settings for grayscale conversion, and it includes steps S1902 to S1904 enclosed by dash-dot-dot line [a] in FIG. 21. The second sequence is performed when the image processing by the printer 901 is selected in the advanced settings for grayscale conversion, and it includes steps S1905 to S1907 enclosed by dash-dot-dot line [b]. The third sequence is performed when both the image processing by the grayscale conversion processing unit 1701 and the image processing by the printer 901 are selected in the advanced settings for grayscale conversion, and it includes steps S1908 to S1911 enclosed by dash-dot-dot line [c].

First, the first sequence will be described. It is assumed that one of “grayscale conversion methods,” “darken,” “convert to solid black,” “distinguish by density,” or “distinguish by edge” is selected in the advanced settings for grayscale conversion. In this case, steps S1901 to S1904 and step S1912 are performed in sequence. As illustrated in FIG. 21, in step S1901, the grayscale conversion processing unit 1701 determines that the printer 901 does not have the function of performing grayscale conversion processes other than the “print in black (K) only” process based on the capability information acquired in step S1205. It is assumed here that one of “grayscale conversion methods,” “darken,” “convert to solid black,” “distinguish by density,” or “distinguish by edge” is set in the advanced settings received in step S807. In this case, it is determined that this setting is to be processed by the grayscale conversion processing unit 1701, and the process proceeds to step S1902.

In step S1902, the intermediate data editing unit 207 of the extension application 902 generates print data using the rendering data and the print settings information. In this step, a grayscale conversion process is performed on print data based on the grayscale conversion setting (any one of “grayscale conversion methods,” “darken,” “convert to solid black,” “distinguish by density,” or “distinguish by edge”) acquired in step S1204. The result of this process is stored in the shared information 208. In addition, the grayscale conversion setting in the print settings information is either edited to “Disable” or deleted from the print settings information.

In step S1903, the intermediate data editing unit 207 generates print data using the rendering data and the print settings information stored in the shared information 208.

In step S1904, the intermediate data editing unit 207 transmits the print data generated in step S1903 to the printer 901.

In step S1912, the printer 901 receives the print data generated in step S1903. The printer 901 then performs image processing, such as color processing and dithering, required to output the print data, and performs printing.

Next, the second sequence will be described. It is assumed that “print in black (K) only” is selected in the advanced settings for grayscale conversion. In this case, step 1901, steps S1905 to S1907, and step 1912 are performed in sequence. In step S1901, the grayscale conversion processing unit 1701 of the extension application 902 determines that the printer 901 does not have the function of performing grayscale conversion processes other than the “print in black (K) only” process based on the capability information acquired in step S1205. It is assumed here that “print in black (K) only” is set in the advanced settings received in step S807. In this case, it is determined that this process can be performed by the printer 901, and the process proceeds to step S1905.

In step S1905, the intermediate data editing unit 207 of the extension application 902 generates print data using the rendering data and the print settings information stored in the shared information 208.

In step S1906, the intermediate data editing unit 207 transmits the print data generated in step S1905 to the printer 901.

In step S1907, the printer 901 receives the print data transmitted in step S1906. The printer 901 then performs a color conversion process on the print data based on the “print in black (K) only” setting.

In step S1912, the printer 901 performs image processing, such as color processing and dithering, required to output the print data that has undergone the color conversion process in step S1907, and performs printing.

Next, the third sequence will be described. It is assumed that one of “grayscale conversion methods,” “darken,” “convert to solid black,” “distinguish by density,” or “distinguish by edge,” along with “print in black (K) only,” is selected in the advanced settings for grayscale conversion. In this case, step S1901 and steps S1908 to S1911 are performed in sequence. In step S1901, the grayscale conversion processing unit 1701 of the extension application 902 determines that the printer 901 does not have the function of performing grayscale conversion processes other than the “print in black (K) only” process based on the capability information acquired in step S1205. It is assumed here that one of the following: “grayscale conversion methods,” “darken,” “convert to solid black,” “distinguish by density,” or “distinguish by edge,” is set along with “print in black (K) only” in the advanced settings received in step S807. In this case, it is determined that one of “grayscale conversion methods,” “darken,” “convert to solid black,” “distinguish by density,” or “distinguish by edge” is to be processed by the grayscale conversion processing unit 1701. Additionally, it is determined that “print in black (K) only” is to be processed by the printer 901. The process then proceeds to step S1908.

In step S1908, the intermediate data editing unit 207 of the extension application 902 generates print data using the rendering data and the print settings information. In this step, a grayscale conversion process is performed on print data based on the grayscale conversion setting (any one of “grayscale conversion methods,” “darken,” “convert to solid black,” “distinguish by density,” or “distinguish by edge”) acquired in step S1204. The result of this process is stored in the shared information 208. In addition, the settings for grayscale conversion processes other than “print in black (K) only” in the print settings information are either edited to “Disable” or deleted from the print settings information.

In step S1909, the intermediate data editing unit 207 generates print data using the rendering data and the print settings information stored in the shared information 208.

In step S1910, the intermediate data editing unit 207 transmits the print data generated in step S1909 to the printer 901.

In step S1911, the printer 901 receives the print data transmitted in step S1910. The printer 901 then performs a color conversion process on the print data based on the “print in black (K) only” setting.

In step S1912, the printer 901 performs image processing, such as color processing and dithering, required to output the print data that has undergone the color conversion process in step S1911, and performs printing.

As described above, the grayscale conversion setting includes two types of settings according to the grayscale conversion function of the printer 901. The first setting is a setting with which printing can be performed by the printer 901. An example of the first setting is “print in black (K) only.” The second setting is a setting with which printing cannot be performed by the printer 901. Examples of the second setting include “darken,” “convert to solid black,” “distinguish by density,” and “distinguish by edge.” When the grayscale conversion setting corresponds to the first setting, the printer 901 can be instructed to perform printing based on the first setting. On the other hand, when the grayscale conversion setting corresponds to the second setting, print data is generated based on the second setting and then transmitted to the printer 901. With this configuration, the printer 901 can be instructed to perform printing according to the type of grayscale conversion setting.

According to the embodiments described above, an image processing apparatus can be instructed to perform grayscale conversion, which converts a color image to a grayscale image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204616, filed Nov. 25, 2024, which is hereby incorporated by reference herein in its entirety.

What is claimed is:

1. A non-transitory computer readable storage medium for storing a computer program configured to support a standard driver that causes an information processing apparatus to obtain capability information of an image processing apparatus according to Internet Printing Protocol, the computer program causing the information processing apparatus to:
display a setting reception screen configured to receive a setting for grayscale conversion to convert a color image to a grayscale image; and
instruct the image processing apparatus to perform the grayscale conversion based on the setting received through the setting reception screen,
wherein the setting reception screen includes a method selection section configured to allow a selection of a method for the grayscale conversion as the setting.

2. The non-transitory computer readable storage medium according to claim 1, wherein the computer program further causes the information processing apparatus to:
obtain, prior to displaying the setting reception screen, capability information from the image processing apparatus regarding a capability of the image processing apparatus to perform printing; and
determine whether the obtained capability information includes information that allows the grayscale conversion to be performed based on the setting.

3. The non-transitory computer readable storage medium according to claim 2, wherein
when it is determined that the obtained capability information includes information that allows the grayscale conversion to be performed based on the setting, the computer program causes the information processing apparatus to instruct the image processing apparatus to perform the grayscale conversion based on the setting received through the setting reception screen, and
when it is determined that the obtained capability information does not include information that allows the grayscale conversion to be performed based on the setting, the computer program causes the information processing apparatus to perform generation and transmission of image data in sequence.

4. The non-transitory computer readable storage medium according to claim 1, wherein
the setting includes a first setting that allows the image processing apparatus to perform the grayscale conversion based on the setting, and a second setting that does not allow the image processing apparatus to perform the grayscale conversion based on the setting,
when the setting corresponds to the first setting, the computer program causes the information processing apparatus to instruct the image processing apparatus to perform the grayscale conversion based on the first setting, and
when the setting corresponds to the second setting, the computer program causes the information processing apparatus to perform generation and transmission of image data in sequence.

5. The non-transitory computer readable storage medium according to claim 1, wherein the setting reception screen further includes a setting selection section configured to allow a selection of whether the setting is enabled or disabled.

6. The non-transitory computer readable storage medium according to claim 1, wherein the method selection section is configured to list a plurality of selectable methods for the grayscale conversion.

7. The non-transitory computer readable storage medium according to claim 6, wherein the methods for the grayscale conversion each use a different ratio of RGB color components.

8. The non-transitory computer readable storage medium according to claim 6, wherein the methods for the grayscale conversion each use a different color component.

9. The non-transitory computer readable storage medium according to claim 8, wherein either using any of CMYK color components or using only K color component is selected to represent black.

10. The non-transitory computer readable storage medium according to claim 1, wherein
the color image includes a plurality of elements constituting the color image, and
the setting reception screen further includes an element selection section configured to allow a selection of an element, from among the plurality of elements, to be subjected to the grayscale conversion, as the setting.

11. The non-transitory computer readable storage medium according to claim 1, wherein the setting reception screen further includes, to allow the setting, at least one of:
a density adjustment section to adjust a density of the grayscale image;
a black representation section to represent the grayscale image in black using a plurality of color materials;
a black representation section to represent the grayscale image using a black color material;
a gradation enhancement section to enhance gradation differences in the grayscale image; and
an edge enhancement section to emphasize contours of elements constituting the grayscale image.

12. The non-transitory computer readable storage medium according to claim 11, wherein the setting reception screen further includes a setting selection section configured to allow a selection of whether the setting made by at least one of the sections is enabled or disabled.

13. The non-transitory computer readable storage medium according to claim 1, wherein the setting reception screen further includes a forced restoration section configured to, as the setting, forcibly restore the setting to an initial state.

14. The non-transitory computer readable storage medium according to claim 1, wherein a function of displaying the method selection section on the setting reception screen is a function that cannot be implemented by the standard driver.

15. A method for supporting a standard driver that causes an information processing apparatus to obtain capability information of an image processing apparatus according to Internet Printing Protocol, the method comprising:
displaying a setting reception screen configured to receive a setting for grayscale conversion to convert a color image to a grayscale image; and
instructing the image processing apparatus to perform the grayscale conversion based on the setting received through the setting reception screen,
wherein the setting reception screen includes a method selection section configured to allow a selection of a method for the grayscale conversion as the setting.

16. An information processing apparatus, comprising:
a standard driver that causes the information processing apparatus to obtain capability information of an image processing apparatus according to Internet Printing Protocol;
one or more processors; and
at least one memory coupled to the one or more processors and having stored thereon instructions for supporting the standard driver which, when executed by the one or more processors, cause the one or more processors to:
display a setting reception screen configured to receive a setting for grayscale conversion to convert a color image to a grayscale image; and
instruct the image processing apparatus to perform the grayscale conversion based on the setting received through the setting reception screen,
wherein the setting reception screen includes a method selection section configured to allow a selection of a method for the grayscale conversion as the setting.
